(19) United States
(12) Patent Application Publication
(10) Pub. No.: US 2021/0068115 A1
(43) Pub. Date: Mar. 4, 2021

(54) BASE STATION APPARATUS AND TERMINAL APPARATUS

(71) Applicants: SHARP KABUSHIKI KAISHA, Sakai City, Osaka (JP); FG Innovation Company Limited, Tuen Mun, New Territories (HK)

(72) Inventors: JUNGO GOTOH, Sakai City, Osaka (JP); OSAMU NAKAMURA, Sakai City, Osaka (JP); SEIJI SATO, Sakai City, Osaka (JP); YASUHIRO HAMAGUCHI, Sakai City, Osaka (JP)

(21) Appl. No.: 16/960,248

(22) PCT Filed: Dec. 27, 2018
(86) PCT No.: PCT/JP2018/048238

§ 371 Date: Jul. 6, 2020

(30) Foreign Application Priority Data
Jan. 9, 2018 (JP) 2018-001188

(51) Int. Cl. H04W 72/04; H04W 76/27; H04L 5/00; H04L 1/00

(52) U.S. Cl. CPC H04W 72/0493; H04W 72/042; H04W 72/0453; H04L 1/0003; H04L 5/0055; H04L 1/0061; H04W 76/27

(57) ABSTRACT

To provide a base station apparatus, a terminal apparatus, and a communication method capable of ensuring high reliability of URLLC using a scheduled access. A base station apparatus for communicating with a terminal apparatus, the base station apparatus including a downlink control signal generation unit configured to generate DCI transmitted through RRC and on a PDCCH, a multiplexing unit configure to multiplex downlink data transmitted on a PDSCH with the DCI, and a transmitter configured to transmit a signal obtained by the multiplexing, wherein the transmitter transmits a frequency domain resource assignment used to transmit at least the downlink data through the RRC, and transmits by use of the DCI at least an NDI indicating an initial transmission or retransmission and information indicating a modulation order and a coding rate, and a transmission signal obtained by performing, on the downlink data, error correction coding using the coding rate and modulation using the modulation order, transmitted by use of the DCI, is transmitted on a frequency resource indicated by the frequency domain resource assignment transmitted through the RRC.

### TECHNICAL FIELD

An aspect of the present invention relates to a base station apparatus and a terminal apparatus. This application claims priority based on Japanese Patent Application No. 2018-001188 filed on Jan. 9, 2018, the contents of which are incorporated herein by reference.

### BACKGROUND ART

In recent years, 5th Generation (5G) mobile telecommunication systems have been focused on, and a communication technology is expected to be specified, the technology establishing MTC mainly based on a large number of terminal apparatuses (Massive Machine Type Communications; mMTC), Ultra-Reliable and Low Latency Communications (URLLC), and enhanced Mobile BroadBand (eMBB). The 3rd Generation Partnership Project (3GPP) has been studying New Radio (NR) as a 5G communication technique and discussing NR Multiple Access (MA).

In 5G, Internet of Things (IoT) is expected to be established that allows connection of various types of equipment not previously connected to a network, and establishment of mMTC is an important issue. In 3GPP, a Machine-to-Machine (M2M) communication technology has already been standardized as Machine Type Communication (MTC) that accommodates terminal apparatuses transmitting and/or receiving small size data (NPL 1). Furthermore, in order to support data transmission at a low rate in a narrow band, standardization of Narrow Band-IoT (NB-IoT) has been conducted (NPL 2). 5G is expected to accommodate more terminals than the above-described standards and to accommodate IoT equipment requiring ultra-reliable and low-latency communications.

On the other hand, in communication systems such as Long Term Evolution (LTE) and LTE-Advanced (LTE-A) which are specified by the 3GPP, terminal apparatuses (User Equipment (UE)) use a Random Access Procedure, a Scheduling Request (SR), and the like, to request a radio resource for transmitting uplink data to a base station apparatus (also referred to as a Base Station (BS) or an evolved Node B (eNB)). The base station apparatus provides uplink transmission grant (UL Grant) to each terminal apparatus based on an SR. In a case that the terminal apparatus receives an UL Grant as control information from the base station apparatus, the terminal apparatus transmits uplink data using a given radio resource (referred to as Scheduled access, grant-based access, or transmission by dynamic scheduling, and hereinafter referred to as scheduled access), based on uplink transmission parameters included in the UL Grant. In this manner, the base station apparatus controls all uplink data transmissions (the base station apparatus knows radio resources for uplink data transmitted by each terminal apparatus). In the scheduled access, the base station apparatus can establish Orthogonal Multiple Access (OMA) by controlling uplink radio resources.

5G mMTC includes a problem in that the use of the scheduled access increases the amount of control information. URLLC includes a problem in that the use of the scheduled access increases delay. As such, a study is underway to utilize grant free access and Semi-persistent scheduling (SPS), where in the grant free access (also referred to as grant less access, Contention-based access, Autonomous access, Resource allocation for uplink transmission without grant, or the like, and hereinafter referred to as grant free access) the terminal apparatus transmits data without performing random access procedure or SR transmission and without performing UL Grant reception, or the like (NPL 3). In the grant free access, increased overhead associated with control information can be suppressed even in a case that a large number of devices transmit small size data. Furthermore, in the grant free access, no UL Grant reception or the like is performed, and thus, the time from generation to transmission of transmission data can be shortened. In the SPS, some of the transmission parameters are notified by use of higher layer control information, and notification is made with an activation UL Grant that indicates the transmission parameters not notified by the higher layer and an approval of use of a periodic resource to enable the data transmission.

It is also anticipated that the URLLC is implemented using a scheduled access that notifies a DL Grant and a UL Grant at each time of data transmission or reception. In this case, a study is underway to implement the low latency by changing a subcarrier spacing (Numerology), the number of OFDM symbols used for the data transmission, and the like.

### CITATION LIST

### Non Patent Literature

NPL 1: 3GPP, TR36.888 V12.0.0, “Study on provision of low-cost Machine-Type Communications (MTC) User Equipments (UEs) based on LTE,” June 2013

NPL 2: 3GPP, TR45.820 V13.0.0, “Cellular system support for ultra-low complexity and low throughput Internet of Things (CIoT),” August 2015

NPL 3: 3GPP, TS38.214 V2.0.0, “Physical layer procedures for data(Release 15),” December 2017

### SUMMARY OF INVENTION

### Technical Problem

In a case that URLLC is implemented using the scheduled access, unless high reliability of the notification of DL Grant and UL Grant as the control information is ensured and high reliability of the notification of ACK/NACK is ensured as well as achieving reliability of the data, the high reliability cannot be ensured, which is a problem.

An aspect of the present invention has been made in view of such circumstances, and an object thereof is to provide a base station apparatus, a terminal apparatus, and a communication method capable of ensuring high reliability of URLLC using a scheduled access.

### Solution to Problem

In order to solve the above-mentioned problems, a base station apparatus, a terminal apparatus, and a communication method according to the present invention are configured as follows.

(1) An aspect of the present invention is a base station apparatus for communicating with a terminal apparatus, the base station apparatus including a downlink control signal generation unit configured to generate a radio resource control (RRC) and a downlink control information (DCI) transmitted on a physical downlink control channel (PDCCH), a multiplexing unit configure to multiplex downlink data transmitted on a physical downlink shared channel (PDSCH) with the DCI, and a transmitter configured to transmit a signal obtained by the multiplexing, wherein the transmitter transmits a frequency domain resource assignment used to transmit at least the downlink data through the RRC, and transmits by use of the DCI at least an NDI indicating an initial transmission or retransmission and information indicating a modulation order and a coding rate, and a transmission signal is transmitted on a frequency resource indicated by the frequency domain resource assignment transmitted through the RRC, the transmission signal being obtained by performing, on the downlink data, error correction coding using the coding rate and modulation using the modulation order, the coding rate and the modulation order being transmitted by use of the DCI.

(2) In an aspect of the present invention, the DCI includes information on a resource for an ACK/NACK of downlink data, and information on transmit power, and the information on the resource for the ACK/NACK indicates a physical uplink shared channel (PUSCH).

(3) In an aspect of the present invention, the information on the transmit power of the ACK/NACK is notified as a transmit power value used for a physical uplink control channel (PUCCH), and the base station apparatus notifies the terminal apparatus that the ACK/NACK is transmitted using the PUSCH with the transmit power for the PUCCH.

(4) In an aspect of the present invention, the DCI includes the number of repetitive transmissions of an identical transport block.

(5) In an aspect of the present invention, the DCI includes at least one of a DCI format identifier, positions and the number of OFDM symbols used for downlink data transmission in a slot transmitting downlink data, or a Redundancy version.

(6) An aspect of the present invention is a terminal apparatus for communicating with a base station apparatus, the terminal apparatus including: a receiver configured to receive a radio resource control (RRC) and a downlink control information (DCI) on a physical downlink control channel (PDCCH); and a transmitter configured to transmit uplink data on a physical uplink shared channel (PUSCH) based on control information included in the RRC and the DCI, wherein the receiver receives at least a frequency domain resource assignment used to transmit the uplink data through the RRC, and receives by use of the DCI at least an NDI indicating an initial transmission or retransmission, and information indicating a modulation order and a coding rate, and a transmission signal is transmitted on a frequency resource indicated by the frequency domain resource assignment received through the RRC, the transmission signal being obtained by performing, on the uplink data, error correction coding using the coding rate and modulation using the modulation order, the coding rate and the modulation order being received by use of the DCI.

(7) In an aspect of the present invention, the receiver receives the DCI including the number of repetitive transmissions of an identical transport block, the number of antenna ports, information on a precoder, information on whether or not transmission diversity is applied, a transmission diversity scheme, and information on transmit power.

(8) In an aspect of the present invention, the receiver receives the DCI including at least one of a DCI format identifier, positions and the number of OFDM symbols used for uplink data transmission in a slot for transmitting uplink data, a Redundancy version, information on transmit power of the PUSCH, or an UL/SUL indicator.

### Advantageous Effects of Invention

According to one or more aspects of the present invention, the terminal apparatus can be efficiently accommodated that performs data transmission for URLLC using grant free access.

### BRIEF DESCRIPTION OF DRAWINGS

FIG. 1 is a diagram illustrating an example of a communication system according to a first embodiment.

FIG. 2 is a diagram illustrating an example of a radio frame structure for the communication system according to the first embodiment.

FIG. 3 is a schematic block diagram illustrating a configuration of a base station apparatus 10 according to the first embodiment.

FIG. 4 is a diagram illustrating an example of a sequence between a base station apparatus and a terminal apparatus according to the first embodiment.

FIG. 5 is a schematic block diagram illustrating a configuration of a terminal apparatus 20 according to the first embodiment.

FIG. 6 is a diagram illustrating an example of a signal detection unit according to the first embodiment.

FIG. 7 is a schematic block diagram illustrating a configuration of a terminal apparatus 20 according to a second embodiment.

FIG. 8 is a diagram illustrating an example of a sequence between a base station apparatus and a terminal apparatus according to the second embodiment.

FIG. 9 is a schematic block diagram illustrating a configuration of a base station apparatus 10 according to the second embodiment.

FIG. 10 is a diagram illustrating an example of a signal detection unit according to the second embodiment.

### DESCRIPTION OF EMBODIMENTS

A communication system according to the present embodiments includes a base station apparatus (also referred to as a cell, a small cell, a pico cell, a serving cell, a component carrier, an eNodeB (eNB), a Home eNodeB, a Low Power Node, a Remote Radio Head, a gNodeB (gNB), a control station, a Bandwidth Part (BWP), or a Supplementary Uplink (SUL)), and a terminal apparatus (also referred to as a terminal, a mobile terminal, a mobile station, or User Equipment (UE)). In the communication system, in case of a downlink, the base station apparatus serves as a transmitting apparatus (a transmission point, a transmit antenna group, or a transmit antenna port group), and the terminal apparatus serves as a receiving apparatus (a reception point, a reception terminal, a receive antenna group, or a receive antenna port group). In a case of an uplink, the base station apparatus serves as a receiving apparatus, and the terminal apparatus serves as a transmitting apparatus. The communication system is also applicable to Device-to-Device (D2D) communication. In this case, the terminal apparatus serves both as a transmitting apparatus and as a receiving apparatus.

The communication system is not limited to data communication between the terminal apparatus and the base station apparatus, the communication involving human beings, but is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme such DFTS-OFDM (Discrete Fourier Transform Spread-Orthogonal Frequency Division Multiplexing, also referred to as Single Carrier-Frequency Division Multiple Access (SC-FDMA)) and Cyclic Prefix-Orthogonal Frequency Division Multiplexing (CP-OFDM). The communication system can also use Filter Bank Multi Carrier (FBMC), Filtered-OFDM (f-OFDM), Universal Filtered-OFDM (UF-OFDM), or Windowing-OFDM (W-OFDM) to which a filter is applied, a transmission scheme using a sparse code (Sparse Code Multiple Access (SCMA)), or the like. Furthermore, the communication system may apply DFT precoding and use a signal waveform for which the filter described above is used. Furthermore, the communication system may apply code spreading, interleaving, the sparse code, and the like in the above-described transmission scheme. Note that, in the description below, at least one of the DFTS-OFDM transmission and the CP-OFDM transmission is used in the uplink, whereas the CP-OFDM transmission is used in the downlink but that the present embodiments are not limited to this configuration and any other transmission scheme is applicable.

The base station apparatus and the terminal apparatus according to the present embodiments can communicate in a frequency band for which an approval of use (license) has been obtained from the government of a country or region where a radio operator provides services, that is, a so-called licensed band, and/or in a frequency band for which no approval of use (license) from the government of the country or region is required, that is, a so-called unlicensed band. In the unlicensed band, communication may be based on carrier sense (e.g., a listen before talk scheme).

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

### First Embodiment

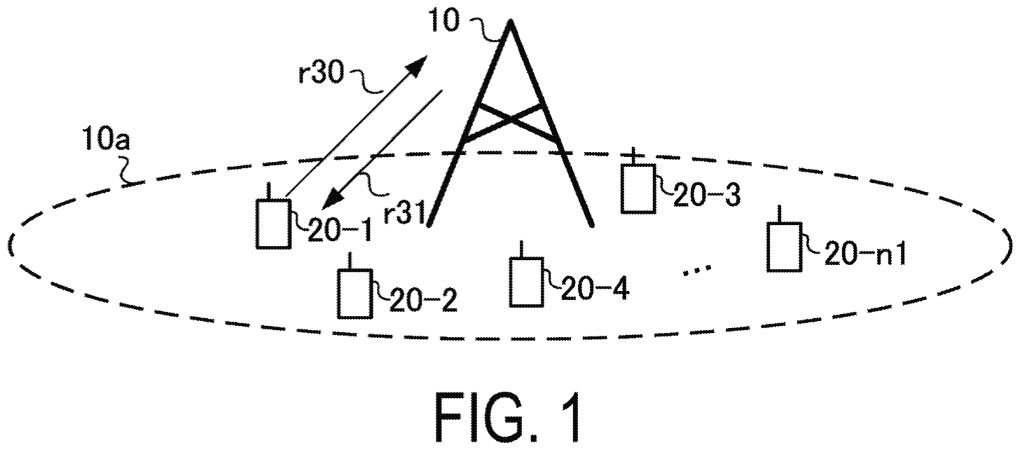

FIG. 1 is a diagram illustrating an example of a configuration of a communication system according to the present embodiment. The communication system according to the present embodiment includes a base station apparatus 10 and terminal apparatuses 20-1 to 20-n1 (n1 is a number of terminal apparatuses connected to the base station apparatus 10). The terminal apparatuses 20-1 and 20-n1 are also collectively referred to as terminal apparatuses 20. Coverage 10a is a range (a communication area) in which the base station apparatus 10 can connect to the terminal apparatus 20 (coverage 10a is also referred to as a cell).

In FIG. 1, radio communication of an uplink r30 includes at least the following uplink physical channels. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is a physical channel that is used to transmit Uplink Control Information (UCI). The uplink control information includes a positive acknowledgement (ACK)/Negative acknowledgement (NACK) in response to downlink data (a Downlink transport block, a Medium Access Control Protocol Data Unit (MAC PDU), a Downlink-Shared Channel (DL-SCH), and a Physical Downlink Shared Channel (PDSCH). The ACK/NACK is also referred to as a Hybrid Automatic Repeat request ACKnowledgement (HARQ-ACK), a HARQ feedback, a HARQ response, or a signal indicating HARQ control information or a delivery confirmation.

The uplink control information includes a Scheduling Request (SR) used to request a PUSCH (Uplink-Shared Channel (UL-SCH)) resource for initial transmission. The scheduling request includes a positive scheduling request or a negative scheduling request. The positive scheduling request indicates that a UL-SCH resource for initial transmission is requested. The negative scheduling request indicates that the UL-SCH resource for the initial transmission is not requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) designating a preferable transmission rate, and the like. The PMI indicates a codebook determined by the terminal apparatus. The codebook is related to precoding of the physical downlink shared channel. The CQI can use an index (CQI index) indicative of a preferable modulation scheme (for example, QPSK, 16QAM, 64QAM, 256QAMAM, or the like), a preferable coding rate, and a preferable frequency utilization efficiency in a prescribed band. The terminal apparatus selects, from the CQI table, a CQI index considered to allow a transport block on the PDSCH to be received within a prescribed block error probability (for example, an error rate of 0.1). Here, the terminal apparatus may have multiple prescribed error probabilities (error rates) for transport blocks. For example, an error rate for eMBB data may be targeted at 0.1 and an error rate for URLLC may be targeted 0.00001. The terminal apparatus may perform CSI feedback for each target error rate (transport block error rate) in a case of being configured by the higher layer (e.g., setup through RRC signaling from the base station), or may perform CSI feedback for a target error rate configured in a case that one of multiple target error rates is configured by the higher layer. Note that the CSI may be calculated using an error rate not for eMBB (e.g. 0.1) depending on not whether the error rate is configured through RRC signaling but whether a CQI table not for eMBB (that is, transmissions where the BLER does not exceed 0.1) is selected.

PUCCH formats 0 to 4 are defined for the PUCCH, and PUCCH formats 0 and 2 are transmitted in 1 to 2 OFDM symbols and PUCCH formats 1, 3, and 4 are transmitted in 4 to 14 OFDM symbols. PUCCH formats 0 and 1 are used for up to 2-bit notification, and can notify only the HARQ-ACK or simultaneously the HARQ-ACK and the SR. PUCCH formats 1, 3, and 4 are used for more than 2-bit notification, and can simultaneously notify the ARQ-ACK, the SR, and the CSI. The number of OFDM symbols used for PUCCH transmission is configured by a higher layer (e.g., setup through RRC signaling), and the use of any PUCCH format depends on whether there is SR transmission or CSI transmission at the timing at which the PUCCH is transmitted (slot, OFDM symbol).

The PUSCH is a physical channel that is used to transmit uplink data (Uplink Transport Block, Uplink-Shared Channel (UL-SCH)). The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit radio resource control (Radio Resource Control (RRC)) signaling. The RRC signaling is also referred to as an RRC message/RRC layer information/an RRC layer signal/an RRC layer parameter/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user equipment-specific (UE-specific) information may be transmitted through signaling dedicated to the certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a Power Headroom (PH) may be included in the MAC CE and may be reported via the physical uplink shared channel. In other words, a MAC CE field is used to indicate a level of the power headroom. The uplink data can include the RRC message and the MAC CE. The RRC signaling and/or the MAC CE is also referred to as a higher layer signal (higher layer signaling). The RRC signaling and/or the MAC CE are included in a transport block.

The PRACH is used to transmit a preamble used for random access. The PRACH is used for indicating the initial connection establishment procedure, the handover procedure, the connection re-establishment procedure, synchronization (timing adjustment) for uplink transmission, and the request for the PUSCH (UL-SCH) resource.

In the uplink radio communication, an Uplink Reference Signal (UL RS) is used as an uplink physical signal. The uplink reference signal includes a Demodulation Reference Signal (DMRS) and a Sounding Reference Signal (SRS). The DMRS is associated with transmission of the physical uplink-shared channel/physical uplink control channel. For example, the base station apparatus 10 uses the demodulation reference signal to perform channel estimation/channel compensation in a case of demodulating the physical uplink-shared channel/physical uplink control channel. For an uplink DMRS, the maximum number of OFDM symbols for front-loaded DMRS and a configuration for the DMRS symbol addition (DMRS-add-pos) are specified by the base station apparatus through the RRC. In a case that the front-loaded DMRS is in 1 OFDM symbol (single symbol DMRS), a frequency domain location, cyclic shift values in the frequency domain, and how different frequency domain locations are used in the OFDM symbol including the DMRS are specified in the DCI, and in a case that the front-loaded DMRS is in 2 OFDM symbols (double symbol DMRS), a configuration for a time spread of a length 2 is specified in the DCI in addition to the above.

The Sounding Reference Signal (SRS) is not associated with the transmission of the physical uplink shared channel/physical uplink control channel. In other words, with or without uplink data transmission, the terminal apparatus transmits periodically or aperiodically the SRS. In the periodic SRS, the terminal apparatus transmits the SRS based on parameters notified through a higher layer signaling (e.g., RRC) from the base station apparatus. On the other hand, in the aperiodic SRS, the terminal apparatus transmits the SRS based on parameters notified through a higher layer signaling (e.g., RRC) from the base station apparatus and a physical downlink control channel (for example, DCI) indicating a transmission timing of the SRS. The base station apparatus 10 uses the SRS to measure an uplink channel state (CSI Measurement). The base station apparatus 10 may perform timing alignment and closed loop transmission power control from measurement results obtained by receiving the SRS.

In FIG. 1, at least the following downlink physical channels are used in radio communication of the downlink r31. The downlink physical channels are used for transmitting information output from the higher layer.
Physical Broadcast Channel (PBCH)
Physical Downlink Control Channel (PDCCH)
Physical Downlink Shared Channel (PDSCH)

The PBCH is used for broadcasting a Master Information Block (MIB, a Broadcast Channel (BCH)) that is used commonly by the terminal apparatuses. The MIB is one of pieces of system information. For example, the MIB includes a downlink transmission bandwidth configuration and a System Frame number (SFN). The MIB may include information indicating at least some of numbers of a slot, a subframe, or a radio frame in which a PBCH is transmitted.

The PDCCH is used to transmit Downlink Control Information (DCI). For the downlink control information, multiple formats based on applications (also referred to as DCI formats) are defined. The DCI format may be defined based on the type and the number of bits of the DCI constituting a single DCI format. The downlink control information includes control information for downlink data transmission and control information for uplink data transmission. The DCI format for downlink data transmission is also referred to as downlink assignment (or downlink grant, DL Grant). The DCI format for uplink data transmission is also referred to as uplink grant (or uplink assignment, UL Grant).

The DCI format for downlink data transmission includes DCI format 1_0, DCI format 1_1, and the like. The DCI format 1_0 is for fallback downlink data transmission, and is constituted by bits the number of which is fewer than DCI format 1-1 supporting MIMO and the like. On the other hand, DCI format 1_1 is capable of notifying MIMO or multiple codewords transmission, ZP CSI-RS trigger, CBG transmission information, and the like, and some fields thereof are added in accordance with the configuration by the higher layer (e.g., RRC signaling, MAC CE). A single downlink assignment is used for scheduling a single PDSCH in a single serving cell. The downlink grant may be used for at least scheduling a PDSCH within the same slot/subframe as the slot/subframe in which the downlink grant has been transmitted. The downlink assignment in DCI format 1_0 includes the following fields. For example, the relevant fields include a DCI format identifier, a frequency domain resource assignment (resource block allocation for the PDSCH, resource allocation), a time domain resource assignment, VRB to PRB mapping, a Modulation and Coding Scheme (MCS) for the PDSCH (information indicating a modulation order and a coding rate), a NEW Data Indicator (NDI) indicating an initial transmission or a retransmission, information for indicating the HARQ process number in the downlink, a Redundancy version (RV) indicating information on redundant bits added to the codeword during error correction coding, Downlink Assignment Index (DAI), a Transmission Power Control (TPC) command for the PUCCH, a resource indicator for the PUCCH, an indicator for HARQ feedback timing from the PDSCH, and the like. Note that the DCI format for each downlink data transmission includes information (fields) required for the application among the above-described information.

The DCI format for uplink data transmission includes DCI format 0_0, DCI format 0_1, and the like. The DCI format 0_0 is for fallback uplink data transmission, and is constituted by bits the number of which is fewer than DCI format 0_1 supporting MIMO and the like. On the other hand, DCI format 0_1 is capable of notifying MIMO or multiple codewords transmission, a SRS resource indicator, precoding information, antenna port information, SRS request information, CSI request information, CBG transmission information, uplink PTRS association, DMRS sequence initialization, and the like, and some fields thereof are added in accordance with the configuration by the higher layer (e.g., RRC signaling). A single uplink grant is used for notifying the terminal apparatus of scheduling of a single PUSCH in a single serving cell. The uplink grant in DCI format 0_0 includes the following fields. For example, the relevant fields include a DCI format identifier, a frequency domain resource assignment (information on resource block allocation for transmitting the PUSCH and a time domain resource assignment, a frequency hopping flag, information on the MCS for the PUSCH, RV, NDI, information indicating the HARQ process number in the uplink, a TPC command for the PUSCH, a Supplemental UL (UL/SUL) indicator, and the like.

For the MCS for the PDSCH/PUSCH, an index (MCS index) indicating a modulation order for the PDSCH/the PUSCH and a target coding rate can be used. The modulation order is associated with a modulation scheme. The modulation orders “2”, “4”, and “6” indicate “QPSK,” “16QAM,” and “64QAM,” respectively. Furthermore, in a case that 256QAM and 1024QAM are configured by the higher layer (e.g., RRC signaling), the modulation orders “8” and “10” can be notified, and indicate “256QAM” and “1024QAM”, respectively. The target coding rate is used to determine a transport block size (TBS) that is the number of bits to be transmitted, depending on the number of resource elements (the number of resource blocks) of the PDSCH/PUSCH scheduled in the PDCCH. A communication system 1 (the base station apparatus 10 and the terminal apparatus 20) shares a method of calculating the transport block size by the MCS, the target coding rate, and the number of resource elements (the number of resource blocks) allocated for the PDSCH/PUSCH transmission.

The PDCCH is generated by adding a Cyclic Redundancy Check (CRC) to the downlink control information. In the PDCCH, CRC parity bits are scrambled with a prescribed identifier (also referred to as an exclusive OR operation, mask). The parity bits are scrambled with a Cell-Radio Network Temporary Identifier (C-RNTI), a Configured Scheduling (CS)-RNTI, a Temporary C (TC)-RNTI, a Paging (P)-RNTI, a System Information (SI)-RNTI, a Random Access (RA)-RNTI, an INT-RNTI, a Slot Format Indicator (SFI)-RNTI, a TPC-PUSCH-RNTI, a TPC-PUCCH-RNTI, or a TPC-SRS-RNTI. The C-RNTI and the CS-RNTI are identifiers for identifying the terminal apparatus in a cell by the dynamic scheduling and the SPS/grant free access, respectively. The Temporary C-RNTI is an identifier for identifying the terminal apparatus that has transmitted a random access preamble in a contention based random access procedure. The C-RNTI and the Temporary C-RNTI are used to control PDSCH transmission or PUSCH transmission in a single subframe. The CS-RNTI is used to periodically allocate a resource for the PDSCH or the PUSCH. The P-RNTI is used to transmit a paging message (Paging Channel (PCH)). The SI-RNTI is used to transmit the SIB, and the RA-RNTI is used to transmit a random access response (message 2 in a random access procedure). The SFI-RNTI is used to notify a slot format. The INT-RNTI is used to notify a Pre-emption. The TPC-PUSCH-RNTI and the TPC-PUCCH-RNTI, and the TPC-SRS-RNTI are used to notify transmission power control values of the PUSCH and the PUCCH, and the SRS, respectively. Note that the identifier may include a CS-RNTI for each configuration in order to configure multiple grant free accesses/SPSs. The DCI to which the CRC scrambled with the CS-RNTI is added can be used for activation, deactivation, parameter change, or retransmission control (ACK transmission) of the grant free access, and the parameter may include a resource configuration (a configuration parameter for a DMRS, a resource in a frequency domain and a time domain of the grant free access, an MCS used for the grant free access, the number of repetitions, with or without applying a frequency hopping, and the like).

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (unique to the cell). That is, the information common to the user equipments in the cell is transmitted using RRC signaling unique to the cell. The RRC signaling transmitted from the base station apparatus may be a message dedicated to a certain terminal apparatus (also referred to as dedicated signaling). In other words, user equipment-specific (UE-Specific) information may be transmitted using a message dedicated to the certain terminal apparatus.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization Signal (SS) and a Downlink Reference Signal (DL RS) are used as downlink physical signals.

The synchronization signal is used for the terminal apparatus to take synchronization in the frequency domain and the time domain in the downlink. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used for the terminal apparatus to measure the downlink channel state (CSI measurement). The downlink reference signal may include a Cell-specific Reference Signal (CRS), a Channel state information Reference Signal (CSI-RS), a Discovery Reference Signal (DRS), and a Demodulation Reference Signal (DMRS).

The downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel. The downlink physical signal and the uplink physical signal are also collectively referred to as a physical signal.

The BCH, the UL-SCH, and the DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

In higher layer processing, processing is performed on a layer higher than the physical layer, such as a Medium Access Control (MAC) layer, a Packet Data Convergence Protocol (PDCP) layer, a Radio Link Control (RLC) layer, and a Radio Resource Control (RRC) layer.

Processing is performed on a layer higher than the physical layer, such as a Medium Access Control (MAC) layer, a Packet Data Convergence Protocol (PDCP) layer, a Radio Link Control (RLC) layer, and a Radio Resource Control (RRC) layer.

A higher layer processing unit configures various RNTIs for each terminal apparatus. The RNTI is used for encryption (scrambling) of the PDCCH, the PDSCH, and the like. In the higher layer processing, the downlink data (transport block, DL-SCH) allocated to the PDSCH, the system information specific to the terminal apparatus (System Information Block: SIB), the RRC message, the MAC CE, and the like are generated or acquired from the higher node and transmitted. In the higher layer processing, various kinds of configuration information of the terminal apparatus 20 are managed. Note that a part of the function of the radio resource control may be performed in the MAC layer or the physical layer.

In the higher layer processing, information on the terminal apparatus, such as the function supported by the terminal apparatus (UE capability), is received from the terminal apparatus 20. The terminal apparatus 20 transmits its own function to the base station apparatus 10 by a higher layer signaling (RRC signaling). The information on the terminal apparatus includes information for indicating whether the terminal apparatus supports a prescribed function or information for indicating that the terminal apparatus has completed introduction and testing of the prescribed function. The information for indicating whether the prescribed function is supported includes information for indicating whether the introduction and testing of the prescribed function have been completed.

In a case that the terminal apparatus supports the prescribed function, the terminal apparatus transmits information (parameters) for indicating whether the prescribed function is supported. In a case that the terminal apparatus does not support a prescribed function, the terminal apparatus may not transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

In FIG. 1, the base station apparatus 10 and the terminal apparatuses 20 support, in the uplink, Multiple Access (MA) using the grant free access (also referred to grant less access, Contention-based access, Autonomous access, Resource allocation for uplink transmission without grant, or the like, and hereinafter referred to as grant free access). The grant free access is a scheme in which the terminal apparatus transmits uplink data (such as a physical uplink channel) without performing a procedure to transmit a SR by the terminal apparatus and specify a physical resource and transmission timing of data transmission by use of a UL Grant using the DCI by the base station apparatus (also referred to as UL Grant through L1 signaling). Thus, the terminal apparatus can receive in advance a physical resource (frequency domain resource assignment) or a transmission parameter that can be used for the grant free access through RRC signaling, and transmit the data using the configured physical resource only in a case that the transmission data is in the buffer. In other words, in a case that the higher layer does not deliver transport blocks to transmit in the grant free access, data transmission in grant free access is not performed.

There are three types of grant free access. A first type is UL-TWG-type1, that is a scheme in which the base station apparatus transmits transmission parameters for the grant free access to the terminal apparatus through higher layer signaling (e.g., RRC), and transmits start of grant (activation, RRC setup) and end of grant (deactivation, RRC release) of the data transmission in the grant free access, and change of the transmission parameters also through higher layer signaling. Here, the transmission parameters for the grant free access may include a physical resource (resource assignment in the time domain and the frequency domain) that can be used for data transmission in the grant free access, a period of the physical resource, an MCS, with or without applying repetitive transmission, the number of repetitions, an RV configuration for repetitive transmission, with or without applying a frequency hopping, a hopping pattern, a DMRS configuration (the number of OFDM symbols for front-loaded DMRS, configurations of cyclic shift and time spread, or the like), the number of HARQ processes, information on transformer precoder, and information on a configuration for TPC. The transmission parameters and the start of grant of the data transmission related to the grant free access may be simultaneously configured, or the start of grant of the data transmission in the grant free access may be configured at different timings (in a case of an SCell, SCell activation, etc.) after the transmission parameters for the grant free access are configured. A second type is UL-TWG-type2, that is a scheme in which the base station apparatus transmits transmission parameters for the grant free access to the terminal apparatus through higher layer signaling (e.g., RRC), and transmits start of grant (activation) and end of grant (deactivation) of the data transmission in the grant free access, and change of the transmission parameters through DCI (L1 signaling). Here, a period of the physical resource, the number of repetitions, an RV configuration for repetitive transmission, the number of HARQ processes, information on transformer precoder, and information on a configuration for TPC may be included in RRC, and the start of grant (activation) based on the DCI may include a physical resource (resource block allocation) that can be used for the grant free access. A third type is a scheme in which the base station apparatus transmits transmission parameters for the grant free access to the terminal apparatus through higher layer signaling (e.g., RRC), and transmits start of grant (activation) and end of grant (deactivation) of the data transmission in the grant free access through higher layer signaling, and transmits only change of the transmission parameters through DCI (L1 signaling). The transmission parameters and the start of grant of the data transmission related to the grant free access may be simultaneously configured, or the start of grant of the data transmission in the grant free access may be configured at different timings after the transmission parameters for the grant free access are configured. The present invention may be applied to any grant free access described above.

On the other hand, Semi-Persistent Scheduling (SPS) technology is introduced in LTE, and periodic resource allocation is possible mainly in VoIP (Voice over Internet Protocol) applications. In the SPS, the DCI is used to perform start of grant (activation) by use of an UL Grant including the transmission parameters such as a physical resource designation (resource blocks allocation) and an MCS. Thus, two types (UL-TWG-type1 and third type) of the start of grant (activation) in the grant free access through higher layer signaling (e.g., RRC) differ from the SPS in the starting procedure. The UL-TWG-type2 is the same as the SPS in that the start of grant (activation) is performed by use of the DCI (L1 signaling), but may be different from the SPS in that it can be used in the SCell, the BWP, and the SUL, and the number of repetitions and an RV configuration for repetitive transmission are notified through RRC signaling. The base station apparatus may perform scrambling with the RNTI types of which are different between the DCI (L1 signaling) used for the grant free access (UL-TWG-type1 and UL-TWG-type2) and the DCI used for the dynamic scheduling, or may perform scrambling with the RNTI the same between the DCI used for the retransmit control of the UL-TWG-type1 and the DCI used for the activation and deactivation and the retransmit control of the UL-TWG-type2.

The base station apparatus 10 and the terminal apparatuses 20 may support non-orthogonal multiple access in addition to orthogonal multiple access. Note that the base station apparatus 10 and the terminal apparatuses 20 can support both the grant free access and scheduled access. Here, a “scheduled access” refers to the terminal apparatus 20 transmitting data according to the following procedure. The terminal apparatus 20 requests a radio resource for transmitting uplink data to the base station apparatus 10 using the random access procedure (Random Access Procedure) or the SR. The base station apparatus provides an UL Grant to each terminal apparatus based on the RACH or the SR by use of the DCI. In a case that the terminal apparatus receives an UL Grant as the control information from the base station apparatus, the terminal apparatus transmits uplink data using a prescribed radio resource based on an uplink transmission parameter included in the UL Grant.

The downlink control information for physical channel transmission in the uplink may include a shared field shared between the scheduled access and the grant free access. In this case, in a case that the base station apparatus 10 indicates transmission of the uplink physical channel using the grant free access, the base station apparatus 10 and the terminal apparatus 20 interpret a bit sequence stored in the shared field in accordance with a configuration for the grant free access (e.g., a look-up table defined for the grant free access). Similarly, in a case that the base station apparatus 10 indicates transmission of the uplink physical channel using the scheduled access, the base station apparatus 10 and the terminal apparatus 20 interpret the shared field in accordance with a configuration for the scheduled access. Transmission of the uplink physical channel in the grant free access is referred to as Asynchronous data transmission. Note that the transmission of the uplink physical channel in the scheduled is referred to as Synchronous data transmission.

In the grant free access, the terminal apparatus 20 may randomly select a radio resource for transmission of uplink data. For example, the terminal apparatus 20 has been notified, by the base station apparatus 10, of multiple candidates for available radio resources as a resource pool, and randomly selects a radio resource from the resource pool. In the grant free access, the radio resource in which the terminal apparatus 20 transmits the uplink data may be configured in advance by the base station apparatus 10. In this case, the terminal apparatus 20 transmits the uplink data using the radio resource configured in advance without receiving the UL Grant (including a physical resource designation) in the DCI. The radio resource includes multiple uplink multiple access resources (resources to which the uplink data can be mapped). The terminal apparatus 20 transmits the uplink data by using one or more uplink multiple access resources selected from the multiple uplink multiple access resources. Note that the radio resource in which the terminal apparatus 20 transmits the uplink data may be predetermined in the communication system including the base station apparatus 10 and the terminal apparatus 20. The radio resource for transmission of the uplink data may be notified to the terminal apparatus 20 by the base station apparatus 10 using a physical broadcast channel (e.g., Physical Broadcast Channel (PBCH)/Radio Resource Control (RRC)/system information (e.g. System Information Block (SIB)/physical downlink control channel (downlink control information, e.g., Physical Downlink Control Channel (PDCCH), Enhanced PDCCH (EPDCCH), MTC PDCCH (MPDCCH), and Narrowband PDCCH (NPDCCH)).

In the grant free access, the uplink multiple access resource includes a multiple access physical resource and a Multi-Access Signature Resource. The multiple access physical resource is a resource including time and frequency. The multiple access physical resource and the multi-access signature resource may be used to identify the uplink physical channel transmitted by each terminal apparatus. The resource blocks are units to which the base station apparatus 10 and the terminal apparatus 20 are capable of mapping the physical channel (e.g., the physical data shared channel or the physical control channel). Each of the resource blocks includes one or more subcarriers (e.g., 12 subcarriers or 16 subcarriers) in a frequency domain.

The multi-access signature resource includes at least one multi-access signature of multiple multi-access signature groups (also referred to as multi-access signature pools). The multi-access signature is information indicating a characteristic (mark or indicator) that distinguishes (identifies) the uplink physical channel transmitted by each terminal apparatus. Examples of the multi-access signature include a spatial multiplexing pattern, a spreading code pattern (a Walsh code, an Orthogonal Cover Code (OCC), a cyclic shift for data spreading, the sparse code, or the like), an interleaving pattern, a demodulation reference signal pattern (a reference signal sequence, the cyclic shift, the OCC, or IFDM)/an identification signal pattern, and transmit power, at least one of which is included in the multi-access signature. In the grant free access, the terminal apparatus 20 transmits the uplink data by using one or more multi-access signatures selected from the multi-access signature pool. The terminal apparatus 20 can notify the base station apparatus 10 of available multi-access signatures. The base station apparatus 10 can notify the terminal apparatus of a multi-access signature used by the terminal apparatus 20 to transmit the uplink data. The base station apparatus 10 can notify the terminal apparatus 20 of an available multi-access signature group by the terminal apparatus 20 to transmit the uplink data. The available multi-access signature group may be notified by using the broadcast channel/RRC/system information/downlink control channel. In this case, the terminal apparatus 20 can transmit the uplink data by using a multi-access signature selected from the notified multi-access signature group.

The terminal apparatus 20 transmits the uplink data by using a multiple access resource. For example, the terminal apparatus 20 can map the uplink data to a multiple access resource including a multi-carrier signature resource including one multiple access physical resource, a spreading code pattern, and the like. The terminal apparatus 20 can also allocate the uplink data to a multiple access resource including a multi-carrier signature resource including one multiple access physical resource and an interleaving pattern. The terminal apparatus 20 can also map the uplink data to a multiple access resource including a multi-access signature resource including one multiple access physical resource and a demodulation reference signal pattern/identification signal pattern. The terminal apparatus 20 can also map the uplink data to a multiple access resource including one multiple access physical resource and a multi-access signature resource including a transmit power pattern (e.g., the transmit power for each of the uplink data may be configured to cause a difference in receive power at the base station apparatus 10). In such grant free access, the communication system of the present embodiment may allow the uplink data transmitted by the multiple terminal apparatuses 20 to overlap (be superimposed, spatial multiplex, non-orthogonally multiplex, collide) with one another in the uplink multiple access physical resource to transmit.

The base station apparatus 10 detects, in the grant free access, a signal of the uplink data transmitted by each terminal apparatus. To detect the uplink data signal, the base station apparatus 10 may include Symbol Level Interference Cancellation (SLIC) in which interference is canceled based on a demodulation result for an interference signal, Codeword Level Interference Cancellation (CWIC, also referred to as Sequential Interference Canceler (SIC) or Parallel Interference Canceler (PIC)) in which interference is canceled based on the decoding result for the interference signal, turbo equalization, maximum likelihood detection (MLD, Reduced complexity maximum likelihood detection (R-MLD)) in which transmit signal candidates are searched for the most probable signal, Enhanced Minimum Mean Square Error-Interference Rejection Combining (EMMSE-IRC) in which interference signals are suppressed by linear computation, signal detection based on message passing (Belief Propagation (BP), Matched Filter (MF)-BP in which a matched filter is combined with BP, or the like. Note that, in the following description, a case is described in which the base station apparatus 10 detects, in the grant free access, a non-orthogonally multiplexed uplink data signal by applying an Advanced Receiver with turbo equalization or the like but that the present embodiment is not limited to this configuration so long as an uplink data signal can be detected. For example, 1—Tap MMSE may be used that does not use a matched filter such as Maximal Ratio Combining (MRC) or an interference canceller.

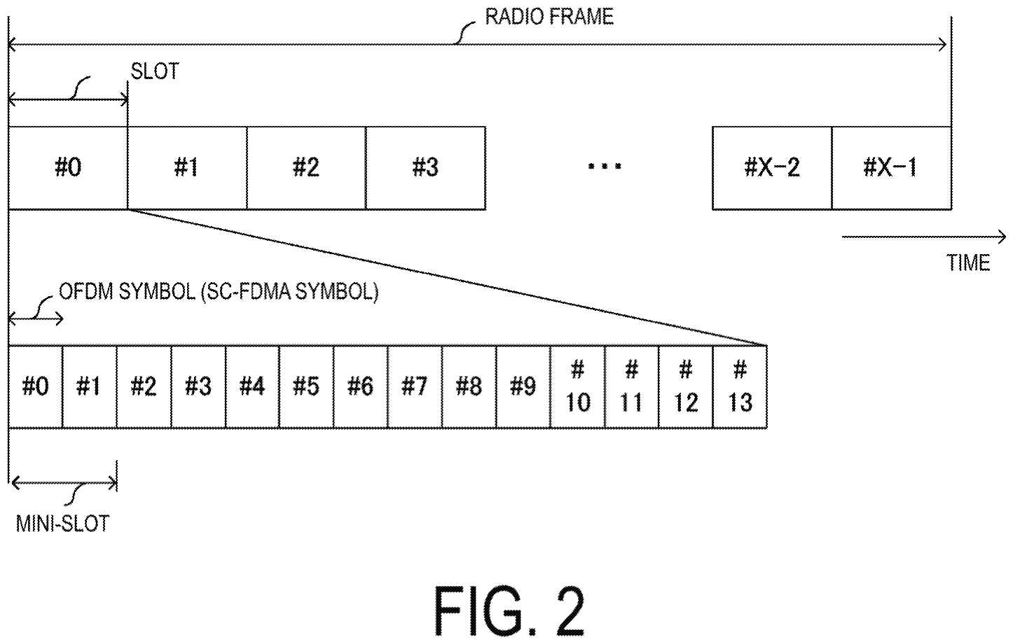

FIG. 2 is a diagram illustrating an example of a radio frame structure for a communication system according to the present embodiment. The radio frame structure indicates a configuration of multiple access physical resources in a time domain. One radio frame includes multiple slots (or may include subframes). FIG. 2 is an example in which one radio frame includes 10 slots. The terminal apparatus 20 has a subcarrier spacing used as a reference (reference numerology). The subframe includes multiple OFDM symbols generated at the subcarrier spacings used as the reference. FIG. 2 is an example in which a subcarrier spacing is 15 kHz, one frame includes 10 slots, one subframe includes one slot, and one slot includes 14 OFDM symbols. In the case that the subcarrier spacing is 15 kHz×2 μ (μ is an integer of 0 or more), one frame includes 2 μ×10 slots and one subframe includes 2 μ slots.

FIG. 2 illustrates a case where the subcarrier spacing used as the reference is the same as a subcarrier spacing used for the uplink data transmission. The communication system according to the present embodiment may use slots as minimum units to which the terminal apparatus 20 maps the physical channel (e.g., the physical data shared channel or the physical control channel). In this case, in the multiple access physical resource, one slot is defined as a resource block unit in the time domain. Furthermore, in the communication system according to the present embodiment, a minimum unit for mapping the physical channel by the terminal apparatus 20 may be one or multiple OFDM symbols (e.g., 2 to 13 OFDM symbols). The base station apparatus 10 has one or multiple OFDM symbols serving as a resource block unit in the time domain. The base station apparatus 10 may signal a minimum unit for mapping a physical channel to the terminal apparatus 20.

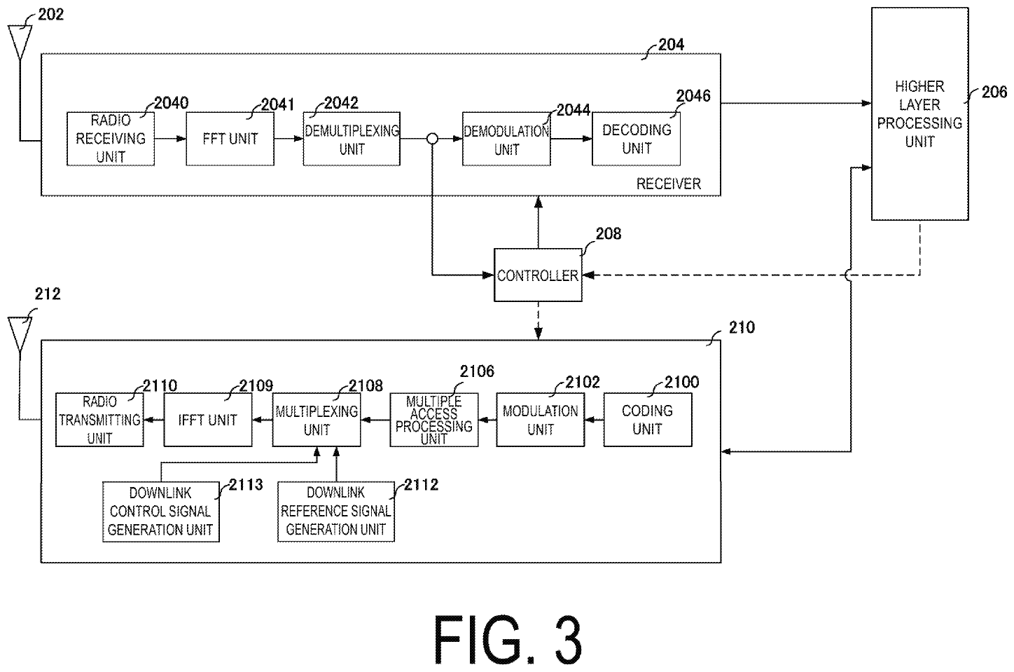

FIG. 3 is a schematic block diagram illustrating a configuration of the base station apparatus 10 according to the present embodiment. The base station apparatus 10 includes a receive antenna 202, a receiver (receiving step) 204, a higher layer processing unit (higher layer processing step) 206, a controller (control step) 208, a transmitter (transmitting step) 210, and a transmit antenna 212. The receiver 204 includes a radio receiving unit (radio receiving step) 2040, an FFT unit 2041 (FFT step), a demultiplexing unit (demultiplexing step) 2042, a demodulation unit (demodulating step) 2044, and a decoding unit (decoding step) 2046. The transmitter 210 includes a coding unit (coding step) 2100, a modulation unit (modulation step) 2102, a multiple access processing unit (multiple access processing step) 2106, a multiplexing unit (multiplexing step) 2108, a radio transmitting unit (radio transmitting step) 2110, a IFFT unit (IFFT step) 2109, a downlink reference signal generation unit (downlink reference signal generation step) 2112, and a downlink control signal generation unit (downlink control signal generation step) 2113.

The receiver 204 demultiplexes, demodulates, and decodes an uplink signal (uplink physical channel, uplink physical signal) received from the terminal apparatus 10 via the receive antenna 202. The receiver 204 outputs a control channel (control information) separated from the received signal to the controller 208. The receiver 204 outputs a decoding result to the higher layer processing unit 206. The receiver 204 acquires the SR and the ACK/NACK and CSI for the downlink data transmission included in the received signal.

The radio receiving unit 2040 converts, by down-conversion, an uplink signal received through the receive antenna 202 into a baseband signal, removes unnecessary frequency components from the baseband signal, controls an amplification level in such a manner as to suitably maintain a signal level, orthogonally demodulates the signal based on an in-phase component and an orthogonal component of the received signal, and converts the resulting orthogonally-demodulated analog signal into a digital signal. The radio receiving unit 2040 removes a portion of the digital signal resulting from the conversion, the portion corresponding to a Cyclic Prefix (CP). The FFT unit 2041 performs a fast Fourier transform on the downlink signal from which CP has been removed (demodulation processing for OFDM modulation), and extracts the signal in the frequency domain.

The demultiplexing unit 2042 separates and extracts the uplink physical channel (physical uplink control channel, physical uplink shared channel), the uplink reference signal, and the like included in the extracted uplink signal in the frequency domain. The demultiplexing unit 2042 includes a channel measurement function (channel measurement unit) using the uplink reference signal. The demultiplexing unit 2042 includes a channel compensation function (channel compensation unit) for the uplink signal using the channel measurement result. The demultiplexing unit outputs the physical uplink channel to the demodulation unit 2044/controller 208.

The demodulation unit 2044 demodulates the receive signal by using, for each of the modulation symbols of each uplink physical channel, a predetermined modulation scheme or a modulation scheme notified in advance by use of the uplink grant, such as BPSK, QPSK, 16QAM, 64QAM, or 256QAM.

The decoding unit 2046 decodes coded bits of each of the demodulated uplink physical channels at a predetermined coding rate of a predetermined coding scheme or at a coding rate notified in advance by use of the uplink grant, and outputs the decoded uplink data/uplink control information to the higher layer processing unit 206.

The controller 208 controls the receiver 204 and the transmitter 210 by using the configuration information related to the uplink reception/configuration information related to the downlink transmission included in the uplink physical channel (physical uplink control channel, physical uplink shared channel, or the like) (notified from the base station apparatus to the terminal apparatus by use of the DCI, RRC, SIB, and the like). The controller 208 acquires the configuration information related to the uplink reception/configuration information related to the downlink transmission from the higher layer processing unit 206. In a case that the transmitter 210 transmits the physical downlink control channel, the controller 208 generates Downlink Control Information (DCI) and outputs the generated information to the transmitter 210. Note that some of the functions of the controller 108 can be included in the higher layer processing unit 102. Note that the controller 208 may control the transmitter 210 in accordance with the parameter of the CP length added to the data signal.

The higher layer processing unit 206 performs processing of the medium access control (MAC) layer, the packet data convergence protocol (PDCP) layer, the radio link control (RLC) layer, and the radio resource control (RRC) layer. The higher layer processing unit 206 receives information, as an input, from the receiver 204, related to a function of the terminal apparatus (UE capability) supported by the terminal apparatus. For example, the higher layer processing unit 206 receives, through signaling in the RRC layer, information related to the function of the terminal apparatus.

The information related to the function of the terminal apparatus includes information indicating whether the terminal apparatus supports a prescribed function, or information indicating that the terminal apparatus has completed introduction and testing of a prescribed function. The information for indicating whether the prescribed function is supported includes information for indicating whether the introduction and testing of the prescribed function have been completed. In a case that the terminal apparatus supports the prescribed function, the terminal apparatus transmits information (parameters) for indicating whether the prescribed function is supported. In a case that the terminal apparatus does not support the prescribed function, the terminal apparatus may be configured not to transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

The information related to the function of the terminal apparatus includes information indicating that the grant free access is supported (information on whether or not each of the UL-TWG-type1 and the UL-TWG-type2 is supported). In a case that multiple functions corresponding to the grant free access are provided, the higher layer processing unit 206 can receive information indicating whether the grant free access is supported on a function-by-function basis. The information indicating that the grant free access is supported includes information indicating the multiple access physical resource and multi-access signature resource supported by the terminal apparatus. The information indicating that the grant free access is supported may include a configuration of a lookup table for the configuration of the multiple access physical resource and the multi-access signature resource. The information indicating that the grant free access is supported may include some or all of an antenna port, a capability corresponding to multiple tables indicating a scrambling identity and the number of layers, a capability corresponding to a prescribed number of antenna ports, and a capability corresponding to a prescribed transmission mode. The transmission mode is determined by the number of antenna ports, transmission diversity, the number of layers, and whether support of the grant free access and the like are provided.

The higher layer processing unit 206 manages various types of configuration information about the terminal apparatus. Some of the various types of configuration information are input to the controller 208. The various types of configuration information are transmitted from the base station apparatus 10 via the transmitter 210 using the downlink physical channel. The various types of configuration information include configuration information related to the grant free access input from the transmitter 210. The configuration information related to the grant free access includes configuration information about the multiple access resources (multiple access physical resources and multi-access signature resources). For example, the configuration information related to the grant free access may include a configuration related to the multi-access signature resource (configuration related to processing performed based on a mark for identifying the uplink physical channel transmitted by the terminal apparatus 20), such as an uplink resource block configuration (a starting position of the OFDM symbol to be used, the number of OFDM symbols/the number of resource blocks), a configuration of the demodulation reference signal/identification signal (reference signal sequence, cyclic shift, OFDM symbols to be mapped, and the like), a spreading code configuration (Walsh code, Orthogonal Cover Code (OCC), sparse code, spreading rates of these spreading codes, and the like), an interleaving configuration, a transmit power configuration, a transmit and/or receive antenna configuration, and a transmit and/or receive beamforming configuration. These multi-access signature resources may be directly or indirectly associated (linked) with one another. The association of the multi-access signature resources is indicated by a multi-access signature process index. The configuration information related to the grant free access may include the configuration of the look-up table for the configuration of the multiple access physical resource and multi-access signature resource. The configuration information related to the grant free access may include setup of the grant free access, information indicating release, ACK/NACK reception timing information for uplink data signals, retransmission timing information for uplink data signals, and the like.

Based on the configuration information related to the grant free access that is notified as the control information, the higher layer processing unit 206 manages multiple access resources (multiple access physical resources, multi-access signature resources) for the uplink data (transport blocks) in grant-free. Based on the configuration information related to the grant free access, the higher layer processing unit 206 outputs, to the controller 208, information used to control the receiver 204.

The higher layer processing unit 206 outputs generated downlink data (e.g., DL-SCH) to the transmitter 210. The downlink data may include a field storing the UE ID (RNTI). The higher layer processing unit 206 adds the CRC to the downlink data. The CRC parity bits are generated using the downlink data. The CRC parity bits are scrambled with the UE ID (RNTI) allocated to the destination terminal apparatus (the scrambling is also referred to as an exclusive-OR operation, masking, or ciphering). However, as described above, the multiple types of RNTI are provided, which are different depending on the data being transmitted, and the like.

In a case that the downlink data to be transmitted is generated, the transmitter 210 transmits the physical downlink shared channel. In a case that the transmitter 210 is transmitting a resource for data transmission by use of the DL Grant, the transmitter 210 may transmit the physical downlink shared channel using the scheduled access, and transmit the physical downlink shared channel using the SPS in a case that the SPS is activated. The transmitter 210 generates the physical downlink shared channel and the demodulation reference signal/control signal associated with the physical downlink shared channel in accordance with the configuration related to the scheduled access/SPS input from the controller 208.

The coding unit 2100 codes the downlink data input from the higher layer processing unit 206 by using the coding scheme that is predetermined or configured by the controller 208 (the coding includes repetitions). The coding scheme may involve application of convolutional coding, turbo coding, Low Density Parity Check (LDPC) coding, Polar coding, and the like. The LDPC code may be used for data transmission, whereas the Polar code may be used for transmission of the control information. Different error correction coding may be used depending on the downlink channel to be used. Different error correction coding may be used depending on the size of the data or control information to be transmitted. For example, the convolution code may be used in a case that the data size is smaller than a prescribed value, and otherwise the correction coding described above may be used. For the coding described above, a mother code such as a low coding rate of ⅓, ⅙ or 1/12 may be used. In a case that a coding rate higher than the mother code is used, the coding rate used for data transmission may be achieved by rate matching (puncturing). The modulation unit 2102 modulates coded bits input from the coding unit 2100, in compliance with a modulation scheme notified by use of the downlink control information or a modulation scheme predetermined for each channel, such as BPSK, QPSK, 16QAM, 64QAM, or 256QAM (the modulation scheme may include π/2 shift BPSK or π/4 shift QPSK).

The multiple access processing unit 2106 performs signal conversion such that the base station apparatus 10 can achieve signal detection even in a case that multiple data are multiplexed on a sequence output from the modulation unit 2102 in accordance with multi-access signature resource input from the controller 208. In a case that the multi-access signature resource is configured as spreading, multiplication by the spreading code sequence is performed according to the configuration of the spreading code sequence. Note that, in a case that interleaving is configured as a multi-access signature resource in the multiple access processing unit 2106, the multiple access processing unit 2106 can be replaced with the interleaving unit. The interleaving unit performs interleaving processing on the sequence output from the modulation unit 2102 in accordance with the configuration of the interleaving pattern input from the controller 208. In a case that code spreading and interleaving are configured as a multi-access signature resource, the multiple access processing unit 2106 of the transmitter 210 performs spreading processing and interleaving. A similar operation is performed even in a case that any other multi-access signature resource is applied, and the sparse code or the like may be applied.

In a case that the OFDM signal waveform is used, the multiple access processing unit 2106 inputs the multiple-access-processed signal to the multiplexing unit 2108. The downlink reference signal generation unit 2112 generates a demodulation reference signal in accordance with the configuration information about the demodulation reference signal input from the controller 208. The configuration information about the demodulation reference signal/identification signal is used to generate a sequence acquired according to a rule predetermined in advance based on information such as the number of OFDM symbols notified by the base station apparatus by use of the downlink control information, the OFDM symbol position in which the DMRS is allocated, the cyclic shift, the time domain spreading, and the like.

The multiplexing unit 2108 multiplexes (maps, allocates) the downlink physical channel and the downlink reference signal to resource elements for each transmit antenna port. In a case that the SCMA is used, the multiplexing unit 2108 allocates the downlink physical channel to the resource elements in accordance with an SCMA resource pattern input from the controller 208.

The IFFT unit 2109 performs the Inverse Fast Fourier Transform (IFFT) on the multiplexed signal to perform OFDM modulation to generate OFDM symbols. The radio transmitting unit 2110 adds CPs to the OFDM-modulated symbols to generate a baseband digital signal. Furthermore, the radio transmitting unit 2110 converts the baseband digital signal into an analog signal, removes the excess frequency components from the analog signal, converts the signal into a carrier frequency by up-conversion, performs power amplification, and transmits the resultant signal to the terminal apparatus 20 via the transmit antenna 212. The radio transmitting unit 2110 includes a transmit power control function (transmit power controller). The transmit power control follows configuration information about the transmit power input from the controller 208. Note that, in a case that FBMC, UF-OFDM, or F-OFDM is applied, filtering is performed on the OFDM symbols in units of subcarriers or sub-bands.

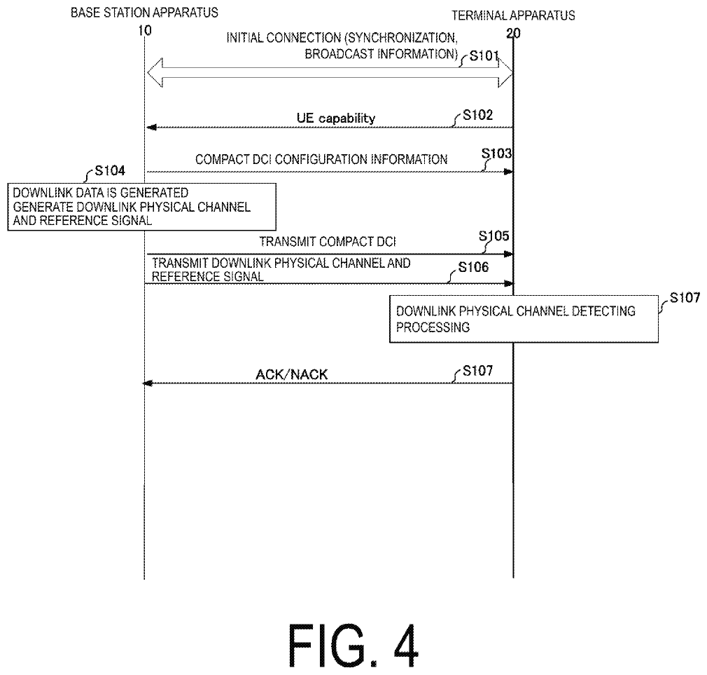

FIG. 4 is a diagram illustrating an example of a sequence between a base station apparatus and a terminal apparatus according to the present embodiment. The base station apparatus 10 periodically transmits a synchronization signal and a broadcast channel in accordance with a prescribed radio frame format in the downlink. The terminal apparatus 20 performs an initial connection by using the synchronization signal, the broadcast channel, and the like (S101). The terminal apparatus 20 performs frame synchronization and symbol synchronization in the downlink by using the synchronization signal. The base station apparatus 10 can notify each terminal apparatus 20 of the UE ID in the initial connection.

The terminal apparatus 20 transmits the UE Capability (S102). Note that in S101 to S103, the terminal apparatus 20 can transmit the physical random access channel to acquire resources for uplink synchronization and an RRC connection request.

The base station apparatus 10 transmits the configuration information related to Compact DCI for URLLC data transmission to each of the terminal apparatuses 20 by using the RRC messages, the SIB, or the like (S103). The configuration information related to the URLLC data transmission includes the allocation of the multi-access signature resource.

In a case that the downlink data is generated, the base station apparatus 10 generates the downlink physical channel and the downlink reference signal (S104). The base station apparatus 10 uses the Compact DCI described later to transmit the DL Grant to the terminal apparatus (S105). The downlink physical channel and the demodulation reference signal are transmitted (initial transmission) (S106).

Based on the result of the error detection, the terminal apparatus 20 transmits the ACK/NACK to the base station apparatus 10 (S107). In S106, in a case that no errors are detected, the terminal apparatus 20 determines to have correctly completed the reception of the downlink data transmitted, and transmits the ACK. On the other hand, in a case that an error is detected in S106, the terminal apparatus 20 determines to have incorrectly received the downlink data received, and transmits the NACK.

The base station apparatus 10 having received the NACK again transmits (retransmits) the downlink physical channel and the reference signal. The base station apparatus 10 further performs error detection processing using the UE ID (RNTI) allocated to each terminal apparatus. Based on the result of the error detection, the base station apparatus 10 transmits the ACK/NACK to the terminal apparatus 20.

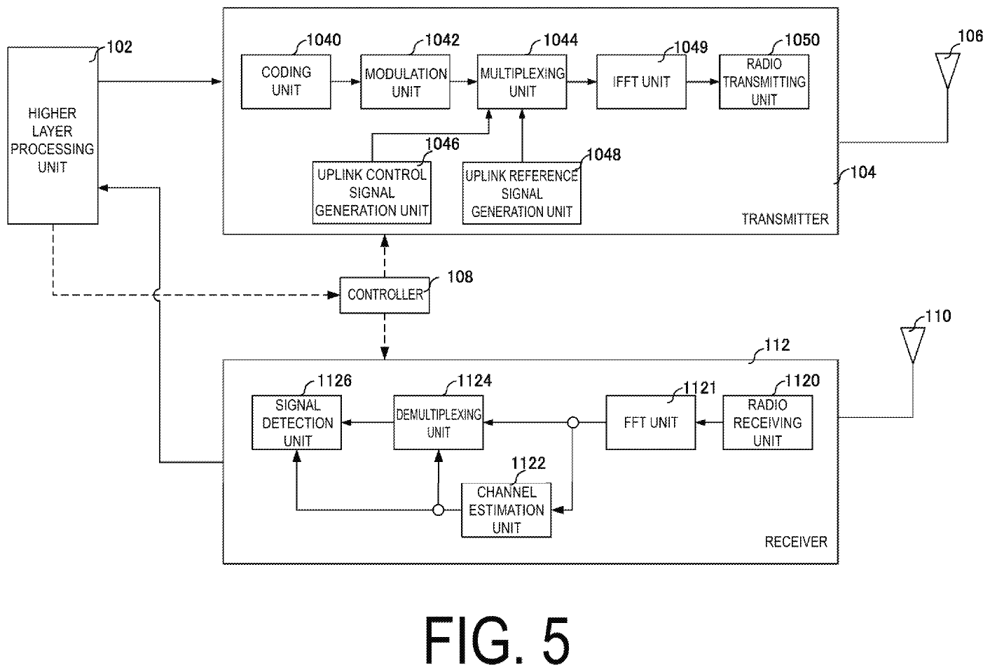

FIG. 5 is a schematic block diagram illustrating a configuration of the terminal apparatus 20 according to the present embodiment. The base station apparatus 10 includes a higher layer processing unit (higher layer processing step) 102, a transmitter (transmitting step) 104, a transmit antenna 106, a controller (control step) 108, a receive antenna 110, and a receiver (receiving step) 112. The transmitter 104 includes a coding unit (coding step) 1040, a modulation unit (modulating step) 1042, a multiplexing unit (multiplexing step) 1044, an uplink control signal generation unit (uplink control signal generating step) 1046, an uplink reference signal generation unit (uplink reference signal generating step) 1048, an IFFT unit 1049 (IFFT step), and a radio transmitting unit (radio transmitting step) 1050. The receiver 112 includes a radio receiving unit (radio receiving step) 1120, an FFT unit (FFT step) 1121, a channel estimation unit (channel estimating step) 1122, a demultiplexing unit (demultiplexing step) 1124, and a signal detection unit (signal detecting step) 1126.

The higher layer processing unit 102 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 102 generates information needed to control the transmitter 104 and the receiver 112, and outputs the resultant information to the controller 108. The higher layer processing unit 102 outputs, to the transmitter 104, uplink data (e.g., UL-SCH), uplink control information, and the like.

The higher layer processing unit 102 receives information related to the terminal apparatus, such as the function of the terminal apparatus (UE capability), from the terminal apparatus 20 (via the receiver 112). The information related to the terminal apparatus includes information indicating that the grant free access is supported, information indicating whether the grant free access is supported on a function-by-function basis. The information indicating that the grant free access is supported and the information indicating whether the grant free access is supported on a function-by-function basis may be distinguished from each other based on the transmission mode. The higher layer processing unit 102 can determine whether the grant free access is supported, depending on the transmission mode supported by the terminal apparatus 20.

Based on the various types of configuration information input from the higher layer processing unit 102, the controller 108 controls the transmitter 104 and the receiver 112. The controller 108 generates the uplink control information (UCI) based on the configuration information related to the control information input from the higher layer processing unit 102, and outputs the generated information to the transmitter 104.

The transmitter 104 codes and modulates the uplink control information, the uplink shared channel, and the like input from the higher layer processing unit 102 for each terminal apparatus, to generate a physical broadcast channel, a physical uplink control channel, and a physical uplink shared channel. The coding unit 1040 codes the uplink control information and the uplink shared channel by using the predetermined coding scheme/coding scheme notified by use of the control information (the coding includes repetitions). The coding scheme may involve application of convolutional coding, turbo coding, Low Density Parity Check (LDPC) coding, Polar coding, and the like. The modulation unit 1042 modulates the coded bits input from the coding unit 1040 by using a predetermined modulation scheme/a modulation scheme notified by use of the control information, such as the BPSK, QPSK, 16QAM, 64QAM, or 256QAM.

The uplink control signal generation unit 1046 adds the CRC to the uplink control information input from the controller 108, to generate a physical uplink control channel. The uplink reference signal generation unit 1048 generates an uplink reference signal.

The multiplexing unit 1044 maps the modulation symbols of each modulated uplink physical channel, the physical uplink control channel, and the uplink reference signal to the resource elements. The multiplexing unit 1044 maps the physical uplink shared channel and the physical uplink control channel to resources allocated to each terminal apparatus.

The IFFT unit 1049 performs Inverse Fast Fourier Transform (IFFT) on the modulation symbols of each multiplexed uplink physical channel to generate OFDM symbols. The radio transmitting unit 1050 adds cyclic prefixes (CPs) to the OFDM symbols to generate a baseband digital signal. Furthermore, the radio transmitting unit 1050 converts the digital signal into an analog signal, removes excess frequency components from the analog signal by filtering, performs up-conversion to the carrier frequency, performs power amplification, and outputs the resultant signal to the transmit antenna 106 for transmission.

The receiver 112 uses the demodulation reference signal to detect the downlink physical channel transmitted from the base station apparatus 10. The receiver 112 detects the downlink physical channel based on the configuration information notified by the base station apparatus by use of the control information (such as DCI, RRC, SIB).

The radio receiving unit 1120 converts, by down-conversion, an uplink signal received through the receive antenna 110 into a baseband signal, removes unnecessary frequency components from the baseband signal, controls the amplification level in such a manner as to suitably maintain a signal level, orthogonally demodulates the signal based on an in-phase component and an orthogonal component of the received signal, and converts the resulting orthogonally-demodulated analog signal into a digital signal. The radio receiving unit 1120 removes a part corresponding to the CP from the converted digital signal. The FFT unit 1121 performs Fast Fourier Transform (FFT) on the signal from which the CPs have been removed, and extracts a signal in the frequency domain.

The channel estimation unit 1122 uses the demodulation reference signal to perform channel estimation for signal detection for the downlink physical channel. The channel estimation unit 1122 receives as inputs, from the controller 108, the resources to which the demodulation reference signal is mapped and the demodulation reference signal sequence allocated to each terminal apparatus. The channel estimation unit 1122 uses the demodulation reference signal sequence to measure the channel state between the base station apparatus 10 and the terminal apparatus 20. The demultiplexing unit 1124 extracts the signal in the frequency domain input from the radio receiving unit 1120 (the signal includes signals from multiple terminal apparatuses 20). The signal detection unit 1126 uses the channel estimation result and the signal in the frequency domain input from the demultiplexing unit 1124 to detect a signal of downlink data (uplink physical channel).

The higher layer processing unit 102 acquires the downlink data (bit sequence resulting from hard decision) from the signal detection unit 1126. The higher layer processing unit 102 performs descrambling (exclusive-OR operation) on the CRC included in the decoded downlink data for each terminal apparatus, by using the UE ID (RNTI) allocated to the terminal. In a case that no error is found in the downlink data as a result of the descrambling error detection, the higher layer processing unit 102 determines that the downlink data has been correctly received.

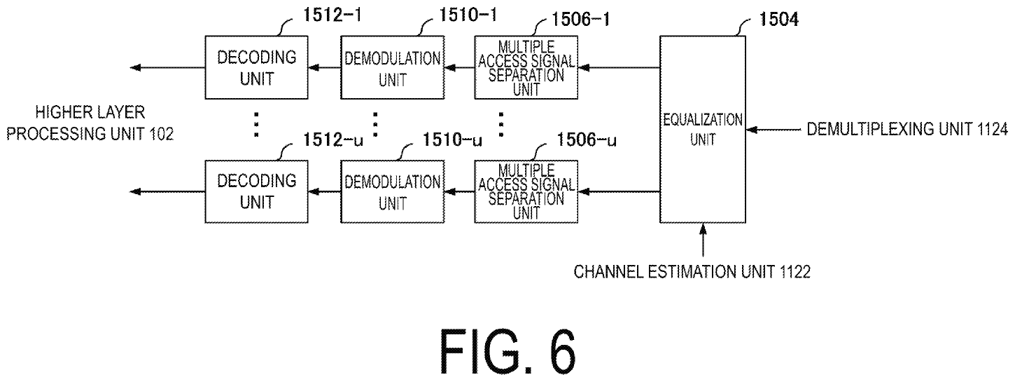

FIG. 6 is a diagram illustrating an example of the signal detection unit according to the present embodiment. The signal detection unit 1126 includes an equalization unit 1504, multiple access signal separation units 1506-1 to 1506-u, demodulation units 1510-1 to 1510-u, and decoding units 1512-1 to 1512-u.

The equalization unit 1504 generates an equalization weight based on the MMSE standard, from the frequency response input from the channel estimation unit 1122. Here, MRC and ZF may be used for the equalization processing. The equalization unit 1504 multiplies the equalization weight by the signal in the frequency domain input from the demultiplexing unit 1124, and extracts the signal in the frequency domain. The equalization unit 1504 outputs the equalized signal in the frequency domain to the multiple access signal separation units 1506-1 to 1506-u. u may be 1.

Each of the multiple access signal separation units 1506-1 to 1506-u separates the signal multiplexed by the multi-access signature resource from the signal in the time domain (multiple access signal separation processing). For example, in a case that code spreading is used as a multi-access signature resource, each of the multiple access signal separation units 1506-1 to 1506-u performs inverse spreading processing using the used spreading code sequence. Note that, in a case that interleaving is applied as a multi-access signature resource, de-interleaving is performed on the signal in the time domain (de-interleaving unit).

The demodulation units 1510-1 to 1510-u receive as an input, from the controller 108, pre-notified or predetermined information about the modulation scheme. Based on the information about the modulation scheme, the demodulation units 1510-1 to 1510-u perform demodulation processing on a signal resulting from separating the multiple access signal, and outputs a Log Likelihood Ratio (LLR) of the bit sequence.

The decoding units 1512-1 to 1512-u receives as an input, from the controller 108, pre-notified or predetermined information about the coding rate. The decoding units 1512-1 to 1512-u perform decoding processing on the LLR sequences output from the demodulation units 1510-1 to 1510-u. In order to perform cancellation processing such as a Successive Interference Canceller (SIC) or turbo equalization, the decoding units 1512-1 to 1512-u may generate replicas from external LLRs or post LLRs output from the decoding units and perform the cancellation processing. A difference between the external LLR and the post LLR is whether to subtract, from the decoded LLR, the pre LLR input to each of the decoding units 1512-1 to 1512-u.

The DL Grant using the Compact DCI for URLLC data transmission according to the present embodiment will be described. The DCI format 1_0 constituted by the smaller number of bits as a conventional DL Grant has fields of a DCI format identifier, a frequency domain resource assignment, a time domain resource assignment, VRB to PRB mapping, an MCS, an NDI, a HARQ process number, an RV, a DAI, a transmission power control command for the PUCCH, a resource indicator for the PUCCH, and an indicator for HARQ feedback timing from the PDSCH. In a case of transmitting a DL Grant in the DCI format, the base station apparatus transmits the DL Grant in a state of being placed in a PDCCH search space. The number of resource elements that can be used for transmitting the DCI format in the search space is determined as an aggregation level. For example, 1 to 16 aggregation levels are provided in NR. The number of resource elements that can be used for transmitting the DCI format is determined from the predetermined aggregation level, and does not depend on the number of bits in the DCI format to be transmitted. Therefore, the greater the number of bits in the DCI format, the higher the coding rate of the transmission. For example, in a case that DCI format 1_0 constituted by the smaller number of bits and DCI format 1_1 constituted by the larger number of bits are transmitted using the number of resource elements at the same aggregation level, the coding rate of DCI format 1_1 is higher. However, in the URLLC data transmission, not only high reliability of the data transmission needs to be ensured, but also high reliability of the DL Grant notifying the terminal apparatus that downlink data transmission is present needs to be ensured. This is because, in a case that the terminal apparatus fails to detect the DL Grant, the terminal apparatus does not detect even downlink data (PDSCH), and therefore, even in a case that only the downlink data is reliable, high reliable downlink data communication is not established. Although the coding rate during the DCI format transmission can be reduced by increasing the aggregation level, more resources for the PDCCH are consumed, and thus, the number of other DCI formats and DCI formats for other terminal apparatuses that can be placed is limited. In the present embodiment, the high reliable downlink data communication is achieved to ensure the high reliability of the DL Grant.

The DL Grant notified by use of DCI format 1_0 is a common format for eMBB, URLLC, and mMTC, and also includes a field other than a field for ensuring the high reliability of the downlink data (PDSCH) transmission. Therefore, in the present embodiment, in the DL Grant notified using the DCI format, only the fields related to the high reliability of the downlink data (PDSCH) transmission or related to both the high reliability and the low latency are notified, and other fields are configured by use of higher layer control information (e.g., RRC signaling). Specifically, among the fields in the conventional DCI format 1_0, only the NDI and the MCS that are the parameters related to the high reliability of the data, the transmission power control command for the PUCCH that is the parameter related to the high reliability of the ACK/NACK for the downlink data, and the resource indicator for the PUCCH may be notified by use of the DCI format, and other fields may be notified by use of the higher layer control information. However, in a case that a field for ensuring high reliability is defined for DCI format 0_0 similar to the DL Grant, the field of the DCI format identifier (the identification of the DL Grant and the UL Grant) may be notified by use of the DCI format. The field of the time domain resource assignment may also be notified by use of the DCI format in order to ensure the low latency. The time domain resource assignment indicates SLIV and K₀ slots after a slot receiving the DL Grant (K₀ is 0 or more). The SLIV is information of a position of the OFDM symbol and the number of OFDM symbols continuous thereto, the position of the OFDM symbol being a position at which data allocation is started in the slot receiving the downlink data. On the other hand, a candidate of K₀ is specified in advance by use of the higher layer control information, and a value of K₀ is determined by the time domain resource assignment. Here, in a case that the number of bits of the time domain resource assignment in DCI format 1_0 is X bits, to achieve low latency, a limitation may be put such that K₀ is fixed to a small value (e.g., K₀=0), and the number of OFDM symbols used for the downlink data transmission is the number of symbols less than 14 OFDM symbols (e.g., equal to or less than 7 OFDM symbols), and Y bits (satisfying Y<X) may be used. For example, in a case of X=7 bits, in a case that the number of OFDM symbols used is limited to 2 or less, and Y=4.

Since the number of bits of the field of the frequency domain resource assignment is very large in the DCI format (e.g., DCI format 1_0 or DCI format 0_0), the significant number of bits can be reduced by migrating from the DL Grant to the higher layer control information. In this manner, by significantly reducing the number of bits in the DCI format, the coding rate during the DCI format transmission is significantly reduced, and the high reliability of the DL Grant can be ensured.

Note that to the Compact DCI format described above, in which the number of bits is reduced, fields for increasing the reliabilities of the downlink data (PDSCH) and the ACK/NACK for the data may be added. For example, in the downlink PDSCH, the number of repetitive transmissions (Repetition number) of the same data (the same transport block) may be notified by use of the Compact DCI format. Note that, similarly, the number of repetitive transmissions (Repetition number) of the ACK/NACK for the data may be notified by use of the Compact DCI format. The downlink data (PDSCH) and the number of repetitive transmissions of the ACK/NACK for the data may be set in common and may be included in one field.

Note that in the Compact DCI format, in order to increase the reliability of the ACK/NACK for the data, a field for transmission on the uplink data channel (PUSCH) may be configured. In this case, the Compact DCI format does not include the transmission power control command for the PUCCH or the resource indicator for the PUCCH, and includes a transmission power control command for the PUSCH and a resource indicator for the PUSCH. The resource indicator for the PUSCH may be a field indicating an index of a resource set to be used among resource sets (e.g., four resource sets) which are notified in advance as candidates, in order to reduce the number of bits. Note that, in a case that the resource indicator for the PUSCH is included in the Compact DCI format, the transmission power control command for the PUCCH may be included. In this case, the base station apparatus may indicate the terminal apparatus to transmit the ACK/NACK for the downlink data transmission on the PUSCH, but may indicate the terminal apparatus to apply the transmit power obtained by a calculation formula of the transmit power for the PUCCH.

Note that, the RV may be included in the Compact DCI format. By notifying the RV by use of the Compact DCI format, retransmission control with incremental redundancy may be possible, and the error rate characteristics during retransmission may be improved. Whether to include the RV in the Compact DCI format may be determined by the higher layer control information (RRC signaling or the like). The Compact DCI format may include the HARQ process number. In this case, the URLLC data transmission can be executed simultaneously in multiple processes. Whether to include the HARQ process number in the Compact DCI format or the upper limit of the HARQ process number may be determined by the higher layer control information (RRC signaling or the like). Note that the smaller number of bits such as two bits may be included in the Compact DCI format as the frequency domain resource assignment. The number of bits of the frequency domain resource assignment depends on the number of available resource blocks, and around 15 bits are needed in LTE 20 MHz. Accordingly, a resource set for downlink data (PDSCH) transmission may be notified in advance through higher layer control signal, and an index specifying a resource set used for the downlink data (PDSCH) transmission may be notified by use of the Compact DCI format. Note that the indicator for HARQ feedback timing from the PDSCH included in DCI format 1_0 may be set to a fixed value to ensure the low latency, or may be specified (configured) by use of the higher layer control information.

Note that the field included in the Compact DCI format may be notified by the base station apparatus to the terminal apparatus by use of the higher layer control information (RRC signaling of the like) that specifies the presence or absence of any field in DCI format 1_0 or DCI format 1_1 in a bitmap. In this case, the fields included in DCI format 1_0 and DCI format 1_1 vary depending on the configuration of the RRC, and thus, the field included in DCI format 1_0 or DCI format 1_1 in which the terminal apparatus attempts to detect with blind decoding may be notified in the bitmap. In a case that the base station apparatus performs the notification in the bitmap, it is meant that the terminal apparatus configures the blind decoding of the number of bits of the Compact DCI format. The base station apparatus may configure the terminal apparatus to perform the blind decoding using the number of bits except for the field notified through the RRC. However, because of complexity that the number of bits notified in the bitmap depends on the configuration content of the RRC, all fields likely to be included in DCI format 1_0 or DCI format 1_1 may be notified in a bitmap. In this case, the number of bits required in the bitmap does not change depending on the configuration content of the RRC and is constant. The field notified as not included in the Compact DCI format in the bitmap may be notified through RRC, may have a fixed value, or may be configured in association with other information.

In the present embodiment, the method for achieving the high reliability of the DL Grant in the downlink URLLC data transmission has been illustrated. In the DCI format for notifying the DL Grant, only the field that achieves high reliability or high reliability and low latency is notified, and the other fields included in the conventional DCI format are notified by use of the higher layer control signal. As a result, the number of bits of the DCI format is reduced, and the DL Grant can be transmitted at a low coding rate. The method for notifying the fields for increasing the reliabilities of the downlink data transmission and the ACK/NACK for the data transmission by use of the DCI format for the downlink URLLC has been illustrated. In this way, the high reliabilities of the DL Grant and downlink data transmission, and the ACK/NACK for the data can be ensured.

### Second Embodiment

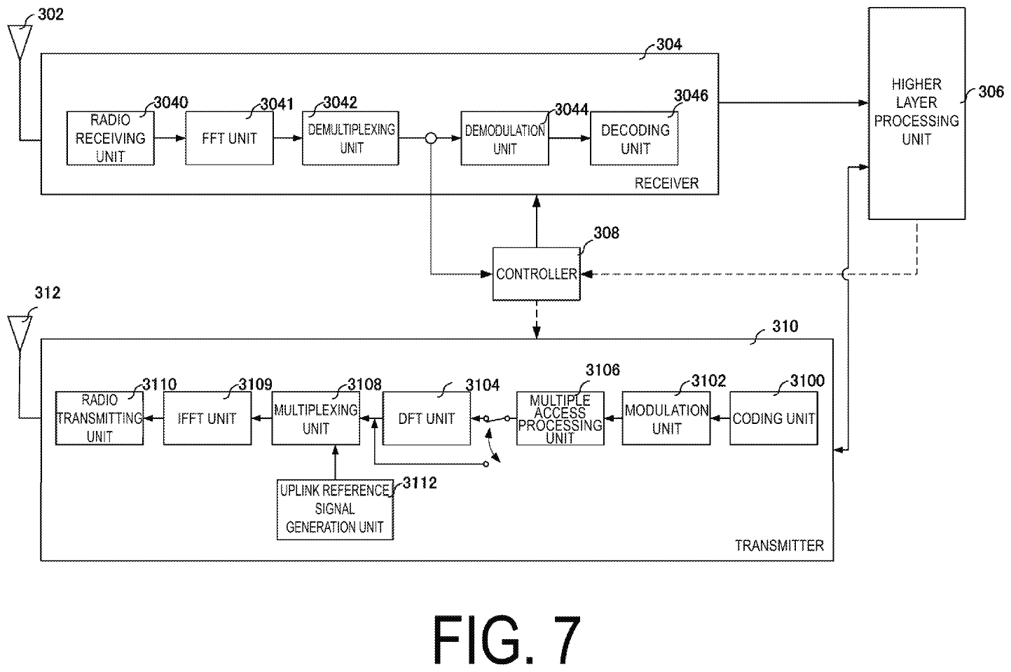

In the present embodiment, the method for achieving the high reliability of the UL Grant in the uplink URLLC data transmission will be described. FIG. 7 illustrates a schematic block diagram illustrating a configuration of the terminal apparatus 20 according to a second embodiment. The terminal apparatus 20 includes a receive antenna 302, a receiver (receiving step) 304, a higher layer processing unit (higher layer processing step) 306, a controller (control step) 308, a transmitter (transmitting step) 310, and a transmit antenna 312. The receiver 304 includes a radio receiving unit (radio receiving step) 3040, an FFT unit 3041 (FFT step), a demultiplexing unit (demultiplexing step) 3042, a demodulation unit (demodulating step) 3044, and a decoding unit (decoding step) 3046. The transmitter 310 includes a coding unit (coding step) 3100, a modulation unit (modulation step) 3102, a DFT unit (DFT step) 3104, a multiple access processing unit (multiple access processing step) 3106, a multiplexing unit (multiplexing step) 3108, a radio transmitting unit (radio transmitting step) 3110, a IFFT unit (IFFT step) 3109, and an uplink reference signal generation unit (uplink reference signal generation step) 3112.

The receiver 304 demultiplexes, demodulates, and decodes a downlink signal (downlink physical channel, downlink physical signal) received from the base station apparatus 10 via the receive antenna 302. The receiver 304 outputs a control channel (control information) separated from the received signal to the controller 308. The receiver 304 outputs a decoding result to the higher layer processing unit 306. The receiver 304 acquires information related to a configuration of the uplink physical channel and the uplink reference signal included in the received signal (referred to as configuration information related to uplink transmission). The configuration information related to the uplink transmission includes configuration information related to the grant free access. The downlink signal may include the UE ID of the terminal apparatus 20.

The radio receiving unit 3040 converts, by down-conversion, a downlink signal received through the receive antenna 302 into a baseband signal, removes unnecessary frequency components from the baseband signal, controls an amplification level in such a manner as to suitably maintain a signal level, orthogonally demodulates the signal based on an in-phase component and an orthogonal component of the received signal, and converts the resulting orthogonally-demodulated analog signal into a digital signal. The radio receiving unit 3040 removes a portion of the digital signal resulting from the conversion, the portion corresponding to a Cyclic Prefix (CP). The FFT unit 3041 performs a fast Fourier transform on the downlink signal from which CP has been removed (demodulation processing for OFDM modulation), and extracts the signal in the frequency domain.

The demultiplexing unit 3042 separates and extracts the downlink physical channel (physical downlink control channel, physical downlink shared channel, physical broadcast channel, or the like), the downlink reference signal, and the like included in the extracted downlink signal in the frequency domain. The demultiplexing unit 3042 includes a channel measurement function (channel measurement unit) using the downlink reference signal. The demultiplexing unit 3042 includes a channel compensation function (channel compensation unit) for the downlink signal using the channel measurement result. The demultiplexing unit outputs the physical downlink channel to the demodulation unit 3044/controller 308.

The demodulation unit 3044 demodulates the receive signal by using, for each of the modulation symbols of each downlink physical channel, a predetermined modulation scheme or a modulation scheme notified in advance by use of the downlink grant, such as BPSK, QPSK, 16QAM, 64QAM, or 256QAM.

The decoding unit 3046 decodes coded bits of each of the demodulated downlink physical channels at a predetermined coding rate of a predetermined coding scheme or at a coding rate notified in advance by use of the downlink grant, and outputs the decoded downlink data/configuration information related to the downlink reception/configuration information related to the uplink transmission to the higher layer processing unit 306.

The controller 308 controls the receiver 304 and the transmitter 310 by using the configuration information related to the downlink reception/configuration information related to the uplink transmission included in the downlink physical channel (physical downlink control channel, physical downlink shared channel, or the like). The configuration information related to the uplink transmission can include configuration information related to the grant free access. The controller 308 controls the uplink reference signal generation unit 3112 and the multiple access processing unit 3106 in accordance with the configuration information related to multiple access resources (multiple access physical resources/multi-access signature resources) included in the configuration information related to the grant free access. In FIG. 7, the controller 308 controls the uplink reference signal generation unit 3112 and the multiple access processing unit 3106 in accordance with parameters and multi-access signature resources used to generate the demodulation reference signal/identification signal calculated from the configuration information related to the grant free access. The controller 308 acquires the configuration information related to the downlink reception/configuration information related to the uplink transmission from the receiver 304/higher layer processing unit 306. The configuration information related to the downlink reception/configuration information related to the uplink transmission may be acquired from the downlink control information (DCI) included in the downlink physical channel. The configuration information related to the downlink reception/configuration information related to the uplink transmission may be acquired from the downlink control information (DCI) included in the downlink physical channel. The configuration information related to the grant free access may be included in the physical downlink control channel/physical downlink shared channel/broadcast channel. The downlink physical channel may include a physical channel dedicated to the grant free access. In this case, a portion or all of the configuration information related to the grant free access may be acquired from the physical channel dedicated to the grant free access. Note that, in a case that the transmitter 310 transmits the physical uplink control channel, the controller 308 generates Uplink Control information (UCI) and outputs the resultant information to the transmitter 310. Note that some of the functions of the controller 108 can be included in the higher layer processing unit 102. Note that, in a case that the transmitter 310 transmits the physical uplink control channel, switching of whether the DFT is to be applied may be performed by the controller 308. Note that the controller 308 may control the transmitter 310 in accordance with the parameter of the CP length added to the data signal. The controller 308 may vary the CP length different between the grant free access and the scheduled access such that the CP for the grant free access is longer than the CP for the scheduled access, for example. The controller 308 may control the transmitter 310 in accordance with the CP length parameter included in the configuration information related to the grant free access. Note that, in a case that the DFT is applied, a Zero-Tail DFTS-OFDM signal waveform may be used in which zero is interpolated at the head/tail of a signal sequence before the sequence is input to the DFT. In a case that the DFT is applied, a UW-DFTS-OFDM signal waveform may be used in which a specific sequence such as a Zadoff-Chu sequence is interpolated at the head/tail of a signal sequence before the sequence is input to the DFT. The DFTS-OFDM may be used in a case that a carrier frequency is lower than a prescribed value, and the Zero-Tail DFTS-OFDM/UW-DFTS-OFDM may be used in a case that the carrier frequency is higher than the prescribed value.

The controller 308 generates control information for retransmission in accordance with a transmission mode corresponding to data to be transmitted and inputs the generated control information to the transmitter 310. Here, the control information for retransmission may be information indicating whether the data requires a low latency or not (information about a required delay) or information indicating whether the transmission mode requires a low latency or not. Herein, the control information for retransmission is used as a general term for the above-described information.

The higher layer processing unit 306 performs processing of the medium access control (MAC) layer, the packet data convergence protocol (PDCP) layer, the radio link control (RLC) layer, and the radio resource control (RRC) layer. The higher layer processing unit 306 outputs, to the transmitter 310, information related to a function of the terminal apparatus (UE capability) supported by the terminal apparatus itself For example, the higher layer processing unit 306 signals, in the RRC layer, information related to the function of the terminal apparatus.

The information related to the function of the terminal apparatus includes information indicating whether the terminal apparatus supports a prescribed function, or information indicating that the terminal apparatus has completed introduction and testing of a prescribed function. The information for indicating whether the prescribed function is supported includes information for indicating whether the introduction and testing of the prescribed function have been completed. In a case that the terminal apparatus supports the prescribed function, the terminal apparatus transmits information (parameters) for indicating whether the prescribed function is supported. In a case that the terminal apparatus does not support the prescribed function, the terminal apparatus may be configured not to transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

The information related to the function of the terminal apparatus includes information indicating that the grant free access is supported. In a case that multiple functions corresponding to the grant free access are provided, the higher layer processing unit 306 can transmit information indicating whether the grant free access is supported on a function-by-function basis. The information indicating that the grant free access is supported includes information indicating the multiple access physical resource and multi-access signature resource supported by the terminal apparatus itself. The information indicating that the grant free access is supported may include a configuration of a lookup table for the configuration of the multiple access physical resource and the multi-access signature resource. The information indicating that the grant free access is supported may include some or all of an antenna port, a capability corresponding to multiple tables indicating a scrambling identity and the number of layers, a capability corresponding to a prescribed number of antenna ports, and a capability corresponding to a prescribed transmission mode. The transmission mode is determined by the number of antenna ports, transmission diversity, the number of layers, and whether support of the grant free access and the like are provided.

The higher layer processing unit 306 manages various types of configuration information about the terminal apparatus itself Some of the various types of configuration information are input to the controller 308. The various types of configuration information are received from the base station apparatus 10 via the receiver 304 using the downlink physical channel. The various types of configuration information include configuration information related to the grant free access input from the receiver 304. The configuration information related to the grant free access includes configuration information about the multiple access resources (multiple access physical resources and multi-access signature resources). For example, the configuration information related to the grant free access may include a configuration related to the multi-access signature resource (configuration related to processing performed based on a mark for identifying the uplink physical channel transmitted by the terminal apparatus 20), such as an uplink resource block configuration (the number of OFDM symbols per resource block/the number of subcarriers), a configuration of the demodulation reference signal/identification signal (reference signal sequence, cyclic shift, OFDM symbols to be mapped, and the like), a spreading code configuration (Walsh code, Orthogonal Cover Code (OCC), sparse code, spreading rates of these spreading codes, and the like), an interleaving configuration, a transmit power configuration, a transmit and/or receive antenna configuration, and a transmit and/or receive beamforming configuration. These multi-access signature resources may be directly or indirectly associated (linked) with one another. The association of the multi-access signature resources is indicated by a multi-access signature process index. The configuration information related to the grant free access may include the configuration of the look-up table for the configuration of the multiple access physical resource and multi-access signature resource. The configuration information related to the grant free access may include setup of the grant free access, information indicating release, ACK/NACK reception timing information for uplink data signals, retransmission timing information for uplink data signals, and the like.

Based on the configuration information related to the grant free access, the higher layer processing unit 306 manages multiple access resources (multiple access physical resources, multi-access signature resources) in which uplink data (transport blocks) is transmitted in a grant-free. Based on the configuration information related to the grant free access, the higher layer processing unit 206 outputs, to the controller 308, information used to control the transmitter 310. The higher layer processing unit 306 acquires the UE ID of the terminal apparatus itself from the receiver 304/controller 308. The UE ID can also be included in configuration information related to the grant free access.

The higher layer processing unit 306 outputs, to the transmitter 310, uplink data (e.g., DL-SCH) generated by a user operation or the like. The higher layer processing unit 306 can also output, to the transmitter 310, uplink data generated without intervention of a user operation (for example, data acquired by the sensor). The uplink data may include a field storing the UE ID. The higher layer processing unit 306 adds the CRC to the uplink data. CRC parity bits are generated using the uplink data. The CRC parity bits are scrambled with the UE ID allocated to the terminal apparatus itself (the scrambling is also referred to as an exclusive-OR operation, masking, or ciphering). As the UE ID, a terminal apparatus-specific identifier for the grant free access may be used.

In a case that uplink data to be transmitted is generated, the transmitter 310 transmits the physical uplink shared channel without receiving the UL Grant, based on the configuration information related to the grant free access and transmitted from the base station apparatus 10. The transmitter 310 generates the physical uplink shared channel and the demodulation reference signal/identification signal associated with the physical uplink shared channel in accordance with the configuration related to the grant free access and input from the controller 308.

The coding unit 3100 codes the uplink data input from the higher layer processing unit 306 by using the predetermined coding scheme/coding scheme configured by the controller 308 (the coding includes repetitions). The coding scheme may involve application of convolutional coding, turbo coding, Low Density Parity Check (LDPC) coding, Polar coding, and the like. The LDPC code may be used for data transmission, whereas the Polar code may be used for transmission of the control information. Different error correction coding may be used depending on the uplink channel to be used. Different error correction coding may be used depending on the size of the data or control information to be transmitted. For example, the convolution code may be used in a case that the data size is smaller than a prescribed value, and otherwise the correction coding described above may be used. For the coding described above, a mother code such as a low coding rate of ⅓, ⅙ or 1/12 may be used. In a case that a coding rate higher than the mother code is used, the coding rate used for data transmission may be achieved by rate matching (puncturing). The modulation unit 3102 modulates coded bits input from the coding unit 3100, in compliance with a modulation scheme notified by use of the downlink control information or a modulation scheme predetermined for each channel, such as BPSK, QPSK, 16QAM, 64QAM, or 256QAM (the modulation scheme may include π/2 shift BPSK or π/2 shift QPSK).

The multiple access processing unit 3106 performs signal conversion such that the base station apparatus 10 can achieve signal detection even in a case that multiple data are multiplexed on a sequence output from the modulation unit 3102 in accordance with multi-access signature resource input from the controller 308. In a case that the multi-access signature resource is configured as spreading, multiplication by the spreading code sequence is performed according to the configuration of the spreading code sequence. The configuration of the spreading code sequence may be associated with other configurations of the grant free access such as the demodulation reference signal/identification signal. Note that the multiple access processing may be performed on the sequence after the DFT processing. Note that, in a case that interleaving is configured as a multi-access signature resource in the multiple access processing unit 3106, the multiple access processing unit 3106 can be replaced with the interleaving unit. The interleaving unit performs interleaving processing on the sequence output from the DFT unit in accordance with the configuration of the interleaving pattern input from the controller 308. In a case that code spreading and interleaving are configured as a multi-access signature resource, the multiple access processing unit 3106 of the transmitter 310 performs spreading processing and interleaving. A similar operation is performed even in a case that any other multi-access signature resource is applied, and the sparse code or the like may be applied.

The multiple access processing unit 3106 inputs the multiple-access-processed signal to the DFT unit 3104 or the multiplexing unit 3108 depending on whether a DFTS-OFDM signal waveform or an OFDM signal waveform is used. In a case that the DFTS-OFDM signal waveform is used, the DFT unit 3104 rearranges multiple-access-processed modulation symbols output from the multiple access processing unit 3106 in parallel and then performs Discrete Fourier Transform (DFT) processing on the rearranged modulation symbols. Here, a zero symbol sequence may be added to the modulation symbols, and the DFT may then be performed to provide a signal waveform in which, instead of a CP, a zero interval is used for a time signal resulting from IFFT. A specific sequence such as Gold sequence or a Zadoff-Chu sequence may be added to the modulation symbols, and the DFT may then be performed to provide a signal waveform in which, instead of a CP, a specific pattern is used for the time signal resulting from the IFFT. In a case that the OFDM signal waveform is used, the DFT is not applied, and thus the multiple-access-processed signal is input to the multiplexing unit 3108. The controller 308 performs control using a configuration of the zero symbol sequence (the number of bits in the symbol sequence and the like) and a configuration of the specific sequence (sequence seed, sequence length, and the like), the configurations being included in the configuration information related to the grant free access.

The uplink reference signal generation unit 3112 generates a demodulation reference signal in accordance with the configuration information about the demodulation reference signal input from the controller 308. The configuration information about the demodulation reference signal/identification signal may be associated with a configuration related to the grant free access (configuration related to the multiple access physical resource/multi-access signature resource). The configuration information about the demodulation reference signal/identification signal is used to generate a sequence acquired according to a predetermined rule (e.g., Equation (1)), based on a physical cell identifier (also referred to as a physical cell identity (PCI), a Cell ID, or the like) for identifying the base station apparatus 10, the number of subcarriers (bandwidth) to which the uplink reference signal is mapped, the number of OFDM symbols, the cyclic shift, the OCC sequence, and the like.

The multiplexing unit 3108 multiplexes (maps) the uplink physical channel (output signal from the DFT unit 3104) and the uplink reference signal for each transmit antenna port. The multiplexing unit 3108 maps the uplink physical channel and the uplink reference signal to resource elements for each transmit antenna port. In a case that the SCMA is used, the multiplexing unit 3108 allocates the uplink physical channel to resource elements in accordance with an SCMA resource pattern input from the controller 308. The SCMA resource pattern may be included in the configuration information related to the grant free access.

The IFFT unit 3109 performs the Inverse Fast Fourier Transform (IFFT) on the multiplexed signal to perform DFTS-OFDM (SC-FDMA) modulation or OFDM modulation to generate SC-FDMA symbols or OFDM symbols. The radio transmitting unit 3110 adds CPs to the SC-FDMA symbols to generate a baseband digital signal. Furthermore, the radio transmitting unit 3110 converts the baseband digital signal into an analog signal, removes the excess frequency components from the analog signal, converts the signal into a carrier frequency by up-conversion, performs power amplification, and transmits the resultant signal to the base station apparatus 10 via the transmit antenna 312. The radio transmitting unit 3110 includes a transmit power control function (transmit power controller). The transmit power control follows configuration information about the transmit power input from the controller 308. The configuration information about the transmit power is associated with the configuration information related to the grant free access. In a case that FBMC, UF-OFDM, or F-OFDM are applied, filtering is performed on the SC-FDMA symbols (or OFDM symbols) in units of subcarriers or sub-bands.

In data transmission in the grant free access, the terminal apparatus 20 can perform mMTC data transmission (hereinafter referred to as an mMTC transmission mode) satisfying at least one of data for which a long delay is acceptable and data not requiring very high reliability, and URLLC data transmission (hereinafter referred to as a URLLC transmission mode) requiring a low latency and high reliability. The mMTC transmission mode may transmit data for which a long delay is acceptable, and the URLLC transmission mode may transmit data for which a low latency is required. The mMTC transmission mode and the URLLC transmission mode may be data transmission based on mMTC configuration information (parameters, configuration information) and data transmission based on URLLC configuration information parameters, configuration information). The mMTC and URLLC configuration information includes a data size, a retransmission count, a bandwidth used for data transmission, a transmit power parameter, a data format, the number of OFDM symbols used for a single data transmission, a subcarrier spacing, a carrier frequency used for data transmission, the number of antenna ports/physical antennas used for data transmission, a modulation order and a coding rate used for data transmission, and the error correction coding scheme, at least one of which may be configured for each transmission mode. So long as any piece of the configuration information is notified for each transmission mode, the configuration value may be the same or different among the transmission modes. The mMTC transmission mode and the URLLC transmission mode may be data transmission on dedicated physical resources for mMTC and data transmission on dedicated physical resources for URLLC. The mMTC transmission mode and the URLLC transmission mode may be data transmission on a dedicated multi-access signature resource for mMTC and data transmission on a dedicated multi-access signature resource for URLLC.

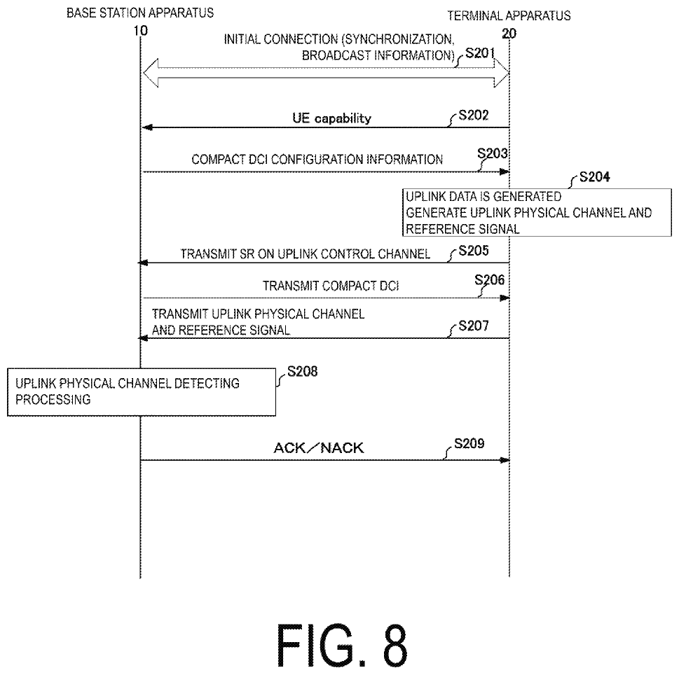

FIG. 8 is a diagram illustrating an example of a sequence between a base station apparatus and a terminal apparatus according to the second embodiment. The base station apparatus 10 periodically transmits a synchronization signal and a broadcast channel in accordance with a prescribed radio frame format in the downlink. The terminal apparatus 20 performs an initial connection by using the synchronization signal, the broadcast channel, and the like (S201). The terminal apparatus 20 performs frame synchronization and symbol synchronization in the downlink by using the synchronization signal. In a case that the broadcast channel includes the configuration information related to the grant free access, the terminal apparatus 20 acquires the configuration related to the grant free access in the connected cell. The base station apparatus 10 can notify each terminal apparatus 20 of the UE ID in the initial connection.

The terminal apparatus 20 transmits the UE Capability (S202). The base station apparatus 10 can identify, by using the UE Capability, whether the terminal apparatus 20 supports the grant free access. Note that in 5201 to 5203, the terminal apparatus 20 can transmit the physical random access channel to acquire resources for uplink synchronization and an RRC connection request.

The base station apparatus 10 transmits the configuration information related to the Compact DCI and the grant free access to each of the terminal apparatuses 20 by using the RRC messages, the SIB, or the like (S203). The configuration information related to the grant free access includes the allocation of the multi-access signature resource. The terminal apparatus 20 having received the configuration information related to the grant free access acquires a transmission parameter such as the multi-access signature resource applied to the uplink data. Note that a portion or all of the configuration information related to the grant free access may be notified using the downlink control information.

In a case that the uplink data is generated, the terminal apparatus 20 generates an SR signal (S204). The terminal apparatus 20 generates an SR signal on the uplink control channel (S205). The base station apparatus 10 uses the Compact DCI described later to transmit the UL Grant to the terminal apparatus (S206). The uplink physical channel and the demodulation reference signal are transmitted (initial transmission) (S207). The physical channel used for data transmission may be transmitted based on a dynamic scheduling UL Grant or based on grant free access/SPS, and the terminal apparatus may transmit on the resource that can be used at the data transmission timing (slot or OFDM symbol). The base station apparatus 10 detects the uplink physical channel transmitted by the terminal apparatus 20 (S208). Based on the result of the error detection, the base station apparatus 10 transmits the ACK/NACK to the base station apparatus 10 (S209). In 5208 in a case that no errors are detected, the base station apparatus 10 determines to have correctly completed the reception of the uplink data received, and transmits the ACK. On the other hand, in a case that an error is detected in 5208, the base station apparatus 10 determines to have incorrectly received the uplink data received, and transmits the NACK.

The base station apparatus 10 performs identification processing on the terminal apparatus 20 by using the demodulation reference signal/identification signal allocated to each terminal apparatus 20. Furthermore, the base station apparatus 10 performs uplink physical channel detection processing on the identified terminal apparatus 20 by using the demodulation reference signal/identification signal, the multi-access signature resource, and the like. The base station apparatus 10 further performs error detection processing using the UE ID allocated to each terminal apparatus (S206). Based on the result of the error detection, the base station apparatus 10 transmits the ACK/NACK to the terminal apparatus 20 (S207). In S106, in a case that no errors are detected, the base station apparatus 10 determines to have correctly completed the identification of the terminal apparatus 20 and the reception of the uplink data transmitted by the terminal apparatus, and transmits the ACK. On the other hand, in a case that an error is detected in 5206, the base station apparatus 10 determines to have incorrectly identified the terminal apparatus 20 or received the uplink data transmitted by the terminal apparatus, and transmits the NACK.

The terminal apparatus 20 having received the NACK again transmits (retransmits) the uplink physical channel and the reference signal. In a case that the base station apparatus 10 indicates a multi-access signature resource for retransmission, the terminal apparatus 20 changes the multi-access signature resource in accordance with a predetermined pattern or the lookup table or the like specified in the control information. The base station apparatus 10 performs uplink physical channel detection processing on the retransmitted uplink physical channel. The base station apparatus 10 further performs error detection processing using the UE ID (RNTI) allocated to each terminal apparatus. Based on the result of the error detection, the base station apparatus 10 transmits the ACK/NACK to the terminal apparatus 20.

The grant free access/SPS may involve application of synchronous HARQ in which the time from the data transmission from the terminal apparatus 20 until the ACK/NACK transmission from the base station apparatus 10 is equal to a predetermined time, and asynchronous HARQ in which the base station apparatus 10 can change ACK/NACK transmission timings. In the mMTC transmission mode, data is transmitted for which a long delay is acceptable, and thus the synchronous HARQ or the asynchronous HARQ may be used. On the other hand, in the URLLC transmission mode, data is transmitted that requires low latency and high reliability. Thus, in a case that the base station apparatus 10 has failed to correctly detect data, retransmission control with a low latency is necessary. For example, synchronous HARQ, asynchronous HARQ, and the like are important in terms of both delay and reliability; in the synchronous HARQ, the ACK/NACK is transmitted in a fixed, short time, and in the asynchronous HARQ, the base station apparatus 10 transmits the ACK/NACK within a short time.

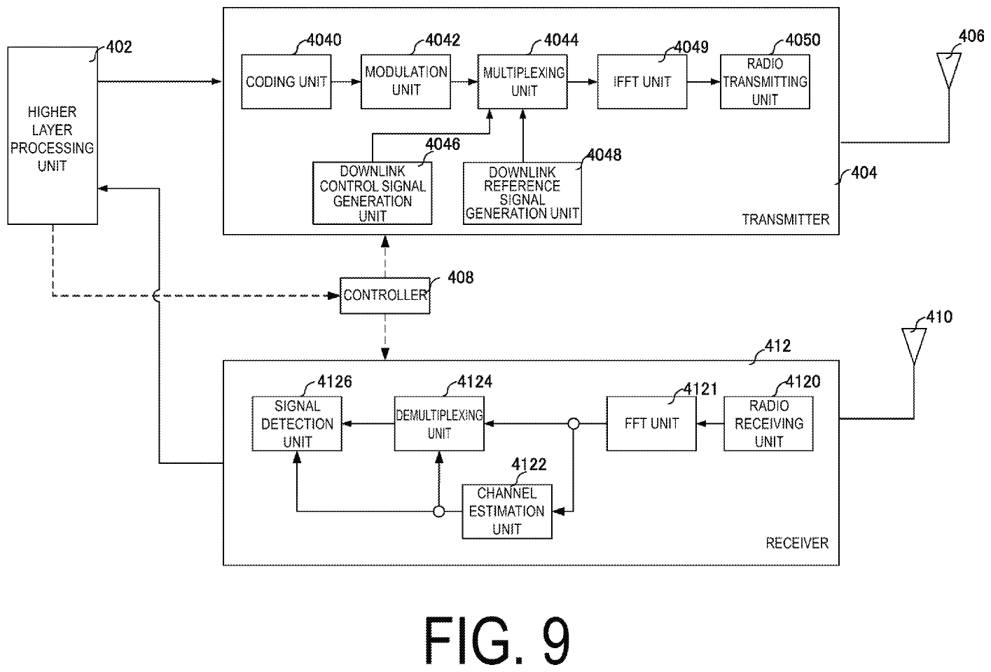

FIG. 9 is a schematic block diagram illustrating a configuration of the base station apparatus 10 according to the present embodiment. The base station apparatus 10 includes a higher layer processing unit (higher layer processing step) 4402, a transmitter (transmitting step) 404, a transmit antenna 406, a controller (control step) 408, a receive antenna 410, and a receiver (receiving step) 412. The transmitter 404 includes a coding unit (coding step) 4040, a modulation unit (modulating step) 4042, a multiplexing unit (multiplexing step) 4044, a downlink control signal generation unit (downlink control signal generating step) 4046, a downlink reference signal generation unit (downlink reference signal generating step) 4048, an IFFT unit 4049 (IFFT step), and a radio transmitting unit (radio transmitting step) 4050. The receiver 412 includes a radio receiving unit (radio receiving step) 4120, an FFT unit (FFT step) 4121, a channel estimation unit (channel estimating step) 4122, a demultiplexing unit (demultiplexing step) 4124, and a signal detection unit (signal detecting step) 4126.

The higher layer processing unit 402 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 402 generates information needed to control the transmitter 404 and the receiver 412, and outputs the resultant information to the controller 408. The higher layer processing unit 402 outputs downlink data (e.g., the DL-SCH), broadcast information (e.g., the BCH), a Hybrid Automatic Request indicator (HARQ indicator), and the like to the transmitter 404.

The higher layer processing unit 402 receives information related to the terminal apparatus, such as the function of the terminal apparatus (UE capability), from the terminal apparatus 20 (via the receiver 412). The information related to the terminal apparatus includes information indicating that the grant free access is supported, information indicating whether the grant free access is supported on a function-by-function basis. The information indicating that the grant free access is supported and the information indicating whether the grant free access is supported on a function-by-function basis may be distinguished from each other based on the transmission mode. The higher layer processing unit 402 can determine whether the grant free access is supported, depending on the transmission mode supported by the terminal apparatus 20.

The higher layer processing unit 402 generates or acquires from a higher node, system information (MIB, SIB) to be broadcasted. The higher layer processing unit 402 outputs, to the transmitter 404, the system information to be broadcasted. The system information to be broadcasted can include information indicating that the base station apparatus 10 supports the grant free access. The higher layer processing unit 402 can include, in the system information, a portion or all of the configuration information related to the grant free access (such as the configuration information related to the multiple access resources such as the multiple access physical resource, the multi-access signature resource). The uplink system control information is mapped to the physical broadcast channel/physical downlink shared channel in the transmitter 404.

The higher layer processing unit 402 generates or acquires from a higher node, downlink data (transport blocks) to be mapped to the physical downlink shared channel, system information (SIB), an RRC message, a MAC CE, and the like, and outputs the downlink data and the like to the transmitter 404. The higher layer processing unit 402 can include, in the higher layer signaling, some or all of the configuration information related to the grant free access and parameters indicating setup and/or release of the grant free access. The higher layer processing unit 402 may generate a dedicated SIB for notifying the configuration information related to the grant free access.

The higher layer processing unit 402 maps the multiple access resources to the terminal apparatuses 20 supporting the grant free access. The base station apparatus 10 may hold a lookup table of configuration parameters for the multi-access signature resource. The higher layer processing unit 402 allocates each configuration parameter to the terminal apparatuses 20. The higher layer processing unit 402 uses the multi-access signature resource to generate configuration information related to the grant free access for each terminal apparatus. The higher layer processing unit 402 generates a downlink shared channel including a portion or all of the configuration information related to the grant free access for each terminal apparatus. The higher layer processing unit 402 outputs, to the controller 408/transmitter 404, the configuration information related to the grant free access.

The higher layer processing unit 402 configures a UE ID for each terminal apparatus and notifies the terminal apparatus of the UE ID. As the UE ID, a Cell Radio Network Temporary Identifier (RNTI) can be used. The UE ID is used for the scrambling of the CRC added to the downlink control channel and the downlink shared channel. The UE ID is used for scrambling of the CRC added to the uplink shared channel. The UE ID is used to generate an uplink reference signal sequence. The higher layer processing unit 402 may configure a SPS/grant free access-specific UE ID. The higher layer processing unit 402 may configure the UE ID separately depending on whether or not the terminal apparatus supports the grant free access. For example, in a case that the downlink physical channel is transmitted in the scheduled access and the uplink physical channel is transmitted in the grant free access, the UE ID for the downlink physical channel may be configured separately from the UE ID for the downlink physical channel. The higher layer processing unit 402 outputs the configuration information related to the UE ID to the transmitter 404/controller 408/receiver 412.

The higher layer processing unit 402 determines the coding rate, the modulation scheme (or MCS), the transmit power for the physical channels (physical downlink shared channel, physical uplink shared channel, and the like), and the like. The higher layer processing unit 402 outputs the coding rate/modulation scheme/transmit power to the transmitter 404/controller 408/receiver 412. The higher layer processing unit 402 can include the coding rate/modulation scheme/transmit power in higher layer signaling.

Based on the various types of configuration information input from the higher layer processing unit 402, the controller 408 controls the transmitter 404 and the receiver 412. The controller 408 generates the downlink control information (DCI), based on the configuration information related to the downlink transmission and the uplink transmission input from the higher layer processing unit 402, and outputs the generated information to the transmitter 404. The controller 408 may include notification of dynamic scheduling transmission parameter and some or all of the configuration information related to the grant free access in the downlink control information.

The controller 408 controls the receiver 412 in accordance with the dynamic scheduling or the configuration information related to the grant free access and input from the higher layer processing unit 402. The controller 408 identifies channel estimation and a terminal apparatus for the channel estimation unit 4122 in accordance with the multi-access signature resource and the demodulation reference signal sequence/identification signal input from the higher layer processing unit 402. The controller 408 outputs, to the signal detection unit 4126, the identification result for the terminal apparatus having transmitted the data, the channel estimation value, the multi-access signature resource used by the identified terminal apparatus, and the like. Note that the function of the controller 408 can be included in the higher layer processing unit 402.

The transmitter 404 codes and modulates the broadcast information, the downlink control information, the downlink shared channel, and the like input from the higher layer processing unit 402 for each terminal apparatus, to generate a physical broadcast channel, a physical downlink control channel, and a physical downlink shared channel. The coding unit 4040 codes the broadcast information, the downlink control information, and the downlink shared channel by using the predetermined coding scheme/coding scheme determined by the higher layer processing unit 402 (the coding includes repetitions). The coding scheme may involve application of convolutional coding, turbo coding, Low Density Parity Check (LDPC) coding, Polar coding, and the like. The modulation unit 4042 modulates the coded bits input from the coding unit 4040, in compliance with the predetermined modulation scheme/modulation scheme determined by the higher layer processing unit 402, such as BPSK, QPSK, 16QAM, 64QAM, or 256QAM.

The downlink control signal generation unit 4046 adds the CRC to the downlink control information input from the controller 408, to generate a physical downlink control channel. The downlink control information includes a portion or all of the configuration information related to the grant free access. The CRC is scrambled with the UE ID allocated to each terminal apparatus. The downlink reference signal generation unit 4048 generates a downlink reference signal. The downlink reference signal is determined in accordance with a predetermined rule based on, e.g., the UE ID for identifying the base station apparatus 10.

The multiplexing unit 4044 maps the modulation symbols of each modulated downlink physical channel, the physical downlink control channel, and the downlink reference signal to the resource elements. The multiplexing unit 4044 maps the physical downlink shared channel and the physical downlink control channel to resources allocated to each terminal apparatus.

The IFFT unit 4049 performs Inverse Fast Fourier Transform (IFFT) on the modulation symbols of each multiplexed downlink physical channel to generate OFDM symbols. The radio transmitting unit 4050 adds cyclic prefixes (CPs) to the OFDM symbols to generate a baseband digital signal. Furthermore, the radio transmitting unit 4050 converts the digital signal into an analog signal, removes excess frequency components from the analog signal by filtering, performs up-conversion to the carrier frequency, performs power amplification, and outputs the resultant signal to the transmit antenna 406 for transmission.

The receiver 412 uses the demodulation reference signal/identification signal to detect the uplink physical channel transmitted from the terminal apparatus 20 by the grant free access. The receiver 412 identifies the terminal apparatus for each terminal apparatus and detects the uplink physical channel, based on the configuration information related to the grant free access configured for each terminal apparatus.

The radio receiving unit 4120 converts, by down-conversion, an uplink signal received through the receive antenna 410 into a baseband signal, removes unnecessary frequency components from the baseband signal, controls the amplification level in such a manner as to suitably maintain a signal level, orthogonally demodulates the signal based on an in-phase component and an orthogonal component of the received signal, and converts the resulting orthogonally-demodulated analog signal into a digital signal. The radio receiving unit 4120 removes a part corresponding to the CP from the converted digital signal. The FFT unit 4121 performs Fast Fourier Transform (FFT) on the signal from which the CPs have been removed, and extracts a signal in the frequency domain.

The channel estimation unit 4122 uses the demodulation reference signal/identification signal to perform identification of the terminal apparatus and channel estimation for signal detection for the uplink physical channel. The channel estimation unit 4122 receives as inputs, from the controller 408, the resources to which the demodulation reference signal/identification signal are mapped and the demodulation reference signal sequence/identification signal allocated to each terminal apparatus. The channel estimation unit 4122 uses the demodulation reference signal sequence/identification signal to measure the channel state between the base station apparatus 10 and the terminal apparatus 20. The channel estimation unit 4122 can identify the terminal apparatus by using the result of channel estimation (impulse response and frequency response with the channel state) (the channel estimation unit 4122 is thus also referred to as an identification unit). The channel estimation unit 4122 determines that an uplink physical channel has been transmitted by the terminal apparatus 20 associated with the demodulation reference signal/identification signal from which the channel state has been successfully extracted. In the resource on which the uplink physical channel is determined by the channel estimation unit 4122 to have been transmitted, the demultiplexing unit 4124 extracts the signal in the frequency domain input from the radio receiving unit 4120 (the signal includes signals from multiple terminal apparatuses 20).

The signal detection unit 4126 uses the channel estimation result and the signal in the frequency domain input from the demultiplexing unit 4124 to detect a signal of uplink data (uplink physical channel) from each terminal apparatus. The signal detection unit 4126 performs detection processing for a signal from the terminal apparatus 20 associated with the demodulation reference signal (demodulation reference signal from which the channel state has been successfully extracted)/identification signal allocated to the terminal apparatus 20 determined to have transmitted the uplink data.

The higher layer processing unit 402 acquires, from the signal detection unit 4126, decoded uplink data (bit sequence resulting from hard decision) for each terminal apparatus. The higher layer processing unit 402 performs descrambling (exclusive-OR operation) on the CRC included in the decoded uplink data for each terminal apparatus, by using the UE ID allocated to the terminal. In a case that no error is found in the uplink data as a result of the descrambling error detection, the higher layer processing unit 402 determines that the identification of the terminal apparatus has been correctly completed and the uplink data transmitted from the terminal apparatus has been correctly received.

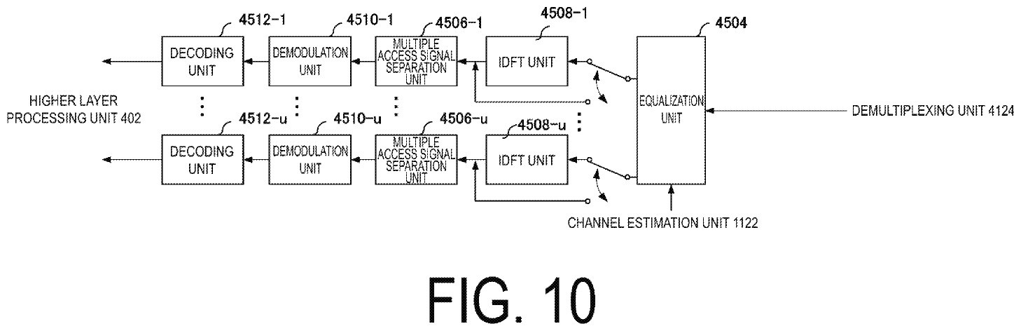

FIG. 10 is a diagram illustrating an example of the signal detection unit according to the present embodiment. The signal detection unit 4126 includes an equalization unit 4504, multiple access signal separation units 4506-1 to 4506-u, IDFT units 4508-1 to 4508-u, demodulation units 4510-1 to 4510-u, and decoding units 4512-1 to 4512-u. u is the number of terminal apparatuses determined by the channel estimation unit 4122 to have transmitted uplink data (for which the channel state has been successfully extracted) on the same multiple access physical resource or overlapping multiple access physical resources (at the same time and at the same frequency). Each of the portions constituting the signal detection unit 4126 is controlled using the configuration related to the grant free access for each terminal apparatus and input from the controller 408.

The equalization unit 4504 generates an equalization weight based on the MMSE standard, from the frequency response input from the channel estimation unit 4122. Here, MRC and ZF may be used for the equalization processing. The equalization unit 4504 multiplies the equalization weight by the signal (including a signal of each terminal apparatus) in the frequency domain input from the demultiplexing unit 4124, and extracts the signal in the frequency domain for each terminal apparatus. The equalization unit 4504 outputs the equalized signal in the frequency domain from each terminal apparatus to the IDFT units 4508-1 to 4508-u. Here, in a case that data is to be detected that is transmitted by the terminal apparatus 20 and that uses the DFTS-OFDM signal waveform, the signal in the frequency domain is output to the IDFT units 4508-1 to 4508-u. In a case that data is to be received that is transmitted by the terminal apparatus 20 and that uses the OFDM signal waveform, the signal in the frequency domain is output to the multiple access signal separation units 4506-1 to 4506-u.

The IDFT units 4508-1 to 4508-u converts the equalized signal in the frequency domain from each terminal apparatus into a signal in the time domain. Note that the IDFT units 4508-1 to 4508-u correspond to processing performed by the DFT unit 2104 of the terminal apparatus 20. The multiple access signal separation units 4506-1 to 4506-u separates the signal multiplexed by the multi-access signature resource from the signal in the time domain from each terminal apparatus after conversion with the IDFT (multiple access signal separation processing). For example, in a case that code spreading is used as a multi-access signature resource, each of the multiple access signal separation units 4506-1 to 4506-u performs inverse spreading processing using the spreading code sequence assigned to each terminal apparatus. Note that, in a case that interleaving is applied as a multi-access signature resource, de-interleaving is performed on the signal in the time domain from each terminal apparatus after conversion with the IDFT (deinterleaving unit).

The demodulation units 4510-1 to 4510-u receive as an input, from the controller 408, pre-notified or predetermined information about the modulation scheme of each terminal apparatus. Based on the information about the modulation scheme, the demodulation units 4510-1 to 4510-u perform demodulation processing on a signal resulting from separating the multiple access signal, and outputs a Log Likelihood Ratio (LLR) of the bit sequence.

The decoding units 4512-1 to 4512-u receives as an input, from the controller 408, pre-notified or predetermined information about the coding rate. The decoding units 4512-1 to 4512-u perform decoding processing on the LLR sequences output from the demodulation units 4510-1 to 4510-u. In order to perform cancellation processing such as a Successive Interference Canceller (SIC) or turbo equalization, the decoding units 4512-1 to 4512-u may generate replicas from external LLRs or post LLRs output from the decoding units and perform the cancellation processing. A difference between the external LLR and the post LLR is whether to subtract, from the decoded LLR, the pre LLR input to each of the decoding units 4512-1 to 1512-u. In a case that the number of repetitions of SIC or turbo equalization is larger than or equal to a prescribed value, the decoding units 4512-1 to 4512-u may perform hard decision on the LLR resulting from the decoding processing, and may output the bit sequence of the uplink data for each terminal apparatus to the higher layer processing unit 402. Note that the signal detection is not limited to that using the turbo equalization processing, and can be replaced with signal detection based on replica generation and using no interference cancellation, maximum likelihood detection, EMMSE-IRC, or the like.

The UL Grant using the Compact DCI for URLLC data transmission according to the present embodiment will be described. The DCI format 0_0 constituted by the smaller number of bits as a conventional UL Grant has fields of a DCI format identifier, a frequency domain resource assignment, a time domain resource assignment, a frequency hopping flag, an MCS, an NDI, an RV, a HARQ process number, a transmission power control command for the PUSCH, and a UL/SUL indicator. In a case of transmitting a UL Grant in the DCI format, the base station apparatus transmits the UL Grant in a state of being placed in a PDCCH search space. The number of resource elements that can be used for transmitting the DCI format in the search space is determined as an aggregation level. For example, 1 to 16 aggregation levels are provided in NR. The number of resource elements that can be used for transmitting the DCI format is determined from the predetermined aggregation level, and does not depend on the number of bits in the DCI format to be transmitted. Therefore, the greater the number of bits in the DCI format, the higher the coding rate of the transmission. For example, in a case that DCI format 0_0 constituted by the smaller number of bits and DCI format 0_1 constituted by the larger number of bits are transmitted using the number of resource elements at the same aggregation level, the coding rate of DCI format 0_1 is higher. However, in the URLLC data transmission, not only high reliability of the data transmission needs to be ensured, but also high reliability of the UL Grant notifying the terminal apparatus that uplink data transmission is present needs to be ensured. This is because, in a case that the terminal apparatus fails to detect the UL Grant, the terminal apparatus does not transmit even uplink data (PUSCH), and therefore, even in a case that only the uplink data is reliable, high reliable uplink data communication is not established. Although the coding rate during the DCI format transmission can be reduced by increasing the aggregation level, more resources for the PDCCH are consumed, and thus, the number of other DCI formats and DCI formats for other terminal apparatuses that can be placed is limited. In the present embodiment, the high reliable uplink data communication is achieved to ensure the high reliability of the UL Grant.

The UL Grant notified by use of DCI format 0_0 is a common format for eMBB, URLLC, and mMTC, and also includes a field other than a field for ensuring the high reliability of the uplink data (PUSCH) transmission. Therefore, in the present embodiment, in the UL Grant notified using the DCI format, only the fields related to the high reliability of the uplink data (PUSCH) transmission or related to both the high reliability and the low latency are notified, and other fields are configured by use of higher layer control information (e.g., RRC signaling). Specifically, among the fields in the conventional DCI format 0_0, only the NDI and the MCS that are the parameters related to the high reliability of the data and the transmission power control command for the PUSCH may be notified by use of the DCI format, and other fields may be notified by use of the higher layer control information. However, in a case that a field for ensuring high reliability is defined for DCI format 1_0 similar to the UL Grant, the field of the DCI format identifier (the identification of the DL Grant and the UL Grant) may be notified by use of the DCI format. The field of the time domain resource assignment may also be notified by use of the DCI format in order to ensure the low latency. The time domain resource assignment indicates SLIV and K₂ slots after a slot receiving the UL Grant (K₂ is 1 or more). The SLIV is information of a position of the OFDM symbol and the number of OFDM symbols continuous thereto, the position of the OFDM symbol being a position at which data allocation is started in the slot transmitting the uplink data. On the other hand, K₂ is specified in advance by use of the higher layer control information, and a value of K₂ is determined by the time domain resource assignment. Here, in a case that the number of bits of the time domain resource assignment in DCI format 0_0 is X bits, in order to satisfy the low latency, a limitation may be put such that K₂ is fixed to a small value (e.g., K₀=1), and the number of OFDM symbols used for the uplink data transmission is the number of symbols less than 14 OFDM symbols (e.g., equal to or less than 7 OFDM symbols), and Y bits (satisfying Y<X) may be used. For example, in a case of X=7 bits, in a case that the number of OFDM symbols used is limited to 2 or less, and Y=4.

Since the number of bits of the field of the frequency domain resource assignment is very large in the DCI format (e.g., DCI format 0_0 or DCI format 1_0), the significant number of bits can be reduced by migrating from the UL Grant to the higher layer control information. Although the number of bits of the time domain resource assignments is high, the significant number of bits can be reduced by putting a limitation to meet the demand for low latency. In this manner, by significantly reducing the number of bits in the DCI format, the coding rate during the DCI format transmission is significantly reduced, and the high reliability of the UL Grant can be ensured.

Note that to the Compact DCI format described above, in which the number of bits is reduced, fields for increasing the reliability of the uplink data (PUSCH) may be added. For example, in the uplink PUSCH, the number of repetitive transmissions (Repetition number) of the same data (the same transport block) may be notified by use of the Compact DCI format. Note that the information on the use of the uplink multi-antenna may be notified by use of the Compact DCI format. Examples of the information on the use of the multi-antenna include information on the number of antenna ports (with which information related to the transmission method of the DMRS may be associated), information on a precoder, information on whether or not the transmission is based on a codebook, information on whether or not transmission diversity is applied and a scheme for transmission diversity, and the like.

Note that information on the target error rate may be included in (or may be added to) the Compact DCI format. In this case, the operation of the data transmission of the terminal apparatus may change depending on the information on the target error rate. For example, in a case that a lower target error rate is specified, a table referenced from the MCS bits is different, an amount of change in the transmit power due to the TPC command for the PUSCH is increased, multiple targeted received powers are configured, where the targeted received power corresponding to the target error rate is used, or the maximum transmit power is used for transmission, and the like. Note that, the RV may be included in the Compact DCI format. By notifying the RV by use of the Compact DCI format, retransmission control with incremental redundancy may be possible, and the error rate characteristics during retransmission may be improved. Whether to include the RV in the Compact DCI format may be determined by the higher layer control information (RRC signaling or the like). The Compact DCI format may include the HARQ process number. In this case, the URLLC data transmission can be executed simultaneously in multiple processes. Whether to include the HARQ process number in the Compact DCI format or the upper limit of the HARQ process number may be determined by the higher layer control information (RRC signaling or the like). Note that the smaller number of bits such as two bits may be included in the Compact DCI format as the frequency domain resource assignment. The number of bits of the frequency domain resource assignment depends on the number of available resource blocks, and around 15 bits are needed in LTE 20 MHz. Accordingly, a resource set for downlink data (PUSCH) transmission may be notified in advance through higher layer control signal, and an index specifying a resource set used for the uplink data (PUSCH) transmission may be notified by use of the Compact DCI format.

Note that, the UL/SUL indicator may be included in the Compact DCI format. By notifying the UL/SUL indicator by use of the Compact DCI format, the uplink coverage can be ensured. Since the uplink has limited transmit power compared to downlink (the base station apparatus transmits a signal), the coverage is narrow, and in particular, in a case that the frequency band used in the uplink has a high frequency (e.g. 3.5 GHz bands), the securing of coverage is important, and therefore, a study is underway to simultaneously configure the SUL using a low frequency band and the UL using a high frequency band. Thus, the UL and the SUL can be dynamically switched by including the UL/SUL indicator in the Compact DCI format. As a result, in a case that the received power of the uplink signal is not sufficiently obtained in the frequency band of the UL in the base station apparatus, the base station apparatus can indicate the SUL switching in the retransmission control of the Compact DCI format.

Note that a Compact DCI format may be used to achieve the high reliability of ACK/NACK for uplink data.

Note that the field included in the Compact DCI format may be notified by the base station apparatus to the terminal apparatus by use of the higher layer control information (RRC signaling of the like) that specifies the presence or absence of any field in DCI format 0_0 or DCI format 0_1 in a bitmap. In this case, the fields included in DCI format 0_0 and DCI format 0_1 vary depending on the configuration of the RRC, and thus, the field included in DCI format 0_0 or DCI format 0_1 in which the terminal apparatus attempts to detect with blind decoding may be notified in the bitmap. In a case that the base station apparatus performs the notification in the bitmap, it is meant that the terminal apparatus configures the blind decoding of the number of bits of the Compact DCI format. The base station apparatus may configure the terminal apparatus to perform the blind decoding using the number of bits except for the field notified through the RRC. However, because of complexity that the number of bits notified in the bitmap depends on the configuration content of the RRC, all fields likely to be included in DCI format 0_0 or DCI format 0_1 may be notified in a bitmap. In this case, the number of bits required in the bitmap does not change depending on the configuration content of the RRC and is constant. The field notified as not included in the Compact DCI format in the bitmap may be notified through RRC, may have a fixed value, or may be configured in association with other information.

In the present embodiment, the method for achieving the high reliability of the DL Grant in the uplink URLLC data transmission has been illustrated. In the DCI format for notifying the UL Grant, only the field that achieves high reliability or high reliability and low latency is notified, and the other fields included in the conventional DCI format are notified by use of the higher layer control signal. As a result, the number of bits of the DCI format is reduced, and the UL Grant can be transmitted at a low coding rate. The method for notifying the fields for increasing the reliabilities of the uplink data transmission and the ACK/NACK for the data transmission by use of the DCI format for the uplink URLLC has been illustrated. In this way, the high reliabilities of the UL Grant and uplink data transmission, and the ACK/NACK for the data can be ensured.

Note that the embodiments herein may be applied in combination with multiple embodiments, or each embodiment only may be applied.

A program running on an apparatus according to the present invention may serve as a program that controls a Central Processing Unit (CPU) and the like to cause a computer to operate in such a manner as to realize the functions of the above-described embodiment according to the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In that case, a program for realizing the functions of the embodiments may be recorded on a computer readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. Furthermore, the above-described program may be one for realizing some of the above-described functions, and also may be one capable of realizing the above-described functions in combination with a program already recorded in a computer system.

Furthermore, each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

The present invention can be preferably used in a base station apparatus, a terminal apparatus, and a communication method.

1. A base station apparatus for communicating with a terminal apparatus, the base station apparatus comprising:
a downlink control signal generation unit configured to generate a radio resource control (RRC) and a downlink control information (DCI) transmitted on a physical downlink control channel (PDCCH); and
a transmitter configured to transmit downlink data transmitted on a physical downlink shared channel (PDSCH) and the DCI, wherein
the transmitter transmits at least a frequency domain resource assignment used to transmit the downlink data through the RRC, and transmits by use of the DCI at least an NDI indicating an initial transmission or retransmission, information indicating a modulation order and a coding rate, information on a resource for an ACK/NACK of downlink data, and information on transmit power,
the information on the resource for the ACK/NACK of downlink data indicates a physical uplink shared channel (PUSCH), and
a transmission signal is transmitted on a frequency resource indicated by the frequency domain resource assignment transmitted through the RRC, the transmission signal being obtained by performing, on the downlink data, error correction coding using the coding rate and modulation using the modulation order, the coding rate and the modulation order being transmitted by use of the DCI,.

2. The base station apparatus according to claim 1, wherein
the information on the transmit power of the ACK/NACK is notified as a transmit power value used for a physical uplink control channel (PUCCH), and the base station apparatus notifies the terminal apparatus that the ACK/NACK is transmitted using the PUSCH with the transmit power for the PUCCH.

3. The base station apparatus according to claim 1, wherein
the DCI includes the number of repetitive transmissions of an identical transport block.

4. The base station apparatus according to claim 1, wherein
the DCI includes at least one of a DCI format identifier, positions and the number of OFDM symbols used for downlink data transmission in a slot for transmitting downlink data, or a Redundancy version.

5. A terminal apparatus for communicating with a base station apparatus, the terminal apparatus comprising:
a receiver configured to receive a radio resource control (RRC) and downlink control information (DCI) on a physical downlink control channel (PDCCH); and
a transmitter configured to transmit uplink data on a physical uplink shared channel (PUSCH) based on control information included in the RRC and the DCI, wherein
the receiver receives at least a frequency domain resource assignment used to transmit the uplink data through the RRC, and receives by use of the DCI at least an NDI indicating an initial transmission or retransmission, and information indicating a modulation order and a coding rate, and
a transmission signal is transmitted on a frequency resource indicated by the frequency domain resource assignment received through the RRC, the transmission signal being obtained by performing, on the uplink data, error correction coding using the coding rate and modulation using the modulation order, the coding rate and modulation order being received by use of the DCI.

6. The terminal apparatus according to claim 5, wherein
the receiver receives the DCI including the number of repetitive transmissions of an identical transport block, the number of antenna ports, information on a precoder, information on whether or not transmission diversity is applied, a transmission diversity scheme, and information on transmit power.

7 . The terminal apparatus according to claim 5, wherein
the receiver receives the DCI including at least one of a DCI format identifier, positions and the number of OFDM symbols used for uplink data transmission in a slot for transmitting uplink data, a Redundancy version, information on transmit power of the PUSCH, or an UL/SUL indicator.
